(19) United States
(12) Patent Application Publication
(10) Pub. No.: US 2006/0155732 A1
(43) Pub. Date: Jul. 13, 2006

(54) Electronic file operation method and layout edition device

(75) Inventors: Hiroaki Momose, NAGANO-KEN (JP); Tatsuya Kitazawa, Nagano (JP); Katsumi Komagamine, Nagano (JP); Tatsuro Oshikawa, Nagano (JP)

Correspondence Address: MARTINE PENILLA & GENCARELLA, LLP, 710 LAKEWAY DRIVE, SUITE 200, SUNNYVALE, CA, 94085, US

(73) Assignee: SEIKO EPSON CORPORATION, TOKYO (JP)

(21) Appl. No.: 10/520,649

(22) PCT Filed: Jul. 9, 2003
(86) PCT No.: PCT/JP03/08735

§ 371 Date: Aug. 30, 2005

(30) Foreign Application Priority Data
Jul. 9, 2002 (JP) 2002-199842
Dec. 13, 2002 (JP) 2002-362209
Dec. 24, 2002 (JP) 2002-372025

(51) Int. Cl. G06F 7/00; G06F 17/30; G06F 17/21

(52) U.S. Cl. 707/101; 707/200; 715/517

(57) ABSTRACT

Selection of a main file and entry of the name of a package file, an output destination folder, etc., are accepted (step S100), the files in the folder of the same name as the main file existing in the same folder as the selected main file are packaged as related files (step S110), and the packaged files are output as a package file based on the entered name and the output destination folder (S120). Consequently, a plurality of electronic files can be packaged for easy handling.

### TECHNICAL FIELD

This invention relates to an electronic file manipulation method and a layout edit apparatus and more particularly to a method used to manipulate an electronic file and a layout edit apparatus for editing the layout of an image area for displaying an image.

The invention also relates to an image processing system and method.

The invention also relates to a display data processing method, a display data structure, and a display data management method.

### BACKGROUND ART

Hitherto, an apparatus for placing an image and a merge image area and editing the layout has been proposed as a layout edit apparatus. In the apparatus, to save the created layout, related electronic files such as an image file used for the layout are stored in a predetermined folder together with the electronic file of the layout.

Compression software for combining a plurality of electronic files into one (for example, “LHA,” “WinZip,” etc.,) has been proposed as an electronic file manipulation program. The program can compress data in the selected electronic file and can package the selected electronic files into one archive.

However, with the layout edit apparatus, to use the saved layout with another computer, etc., the generated electronic files must be all copied for use and if the number of files is large, etc., a great deal of time and labor become necessary. The program such as the compression software described above can package a plurality of electronic files into one file, but the electronic files to be packaged must be selected separately and time and labor are required as a plurality of electronic files are copied.

It is an object of the invention to provide an electronic file manipulation program that can package a plurality of electronic files for easy handling. It is an object of the invention to provide an electronic file manipulation program for easily packaging and unpackaging a plurality of files. It is an object of the invention to provide a layout edit apparatus for facilitating transfer of an electronic file concerning a layout.

Hitherto, a program edit apparatus for outputting a layout definition file defining a layout for printing a digital image and a printer for printing a digital image based on a layout definition file stored in removable memory have been known (for example, refer to patent document 1). In the invention in patent document 1, the program edit apparatus generates a setting program (layout definition file) setting the output conditions (layout) of image data (digital image) and stores the setting program in a record medium, and the printer executes the setting program for printing the image data based on the output conditions.

(Patent document 1)

JP-A-2001-45352

However, according to the program edit apparatus and the printer disclosed in patent document 1, the digital image file representing a digital image and the layout definition file must be handled separately and therefore handling becomes burdensome and portability is degraded; this is a problem. For example, assume that one user wants to distribute a digital image file and a layout definition file for displaying a digital image represented by the digital image file to friends each having a printer in such a manner that the files are copied into a record medium or are attached to electronic mail. In this case, if the digital image file and the layout definition file are separate, time and labor are required for copying or attaching the files and in addition, there is a possibility that an error of forgetting about copying one file or the like may occur.

It is an object of the invention to provide an image processing system and method, a layout edit method and apparatus, and a display data processing method and apparatus for making it possible to improve portability of a digital image file and a layout definition file.

There is a possibility that information to be essentially used in one body such as the digital image file and its layout definition file described above may contain information corresponding to an illegal act if the information is used solely from the restriction of a copyright, etc. For example, a template for the user to merge a photo image for print is made up of an image file representing an illustration and a layout definition file defining the layout of the illustration and the photo image and the use limitation by copyright is set in the illustration. If use of the illustration is permitted only when the illustration is used with the template, it is necessary to inhibit so-called secondary use of the illustration such as diversion of the image file representing the illustration to a document other than the template or distribution of the image file representing the illustration to other persons.

It is an object of the invention to provide a display data processing method and apparatus, a file data structure, and a display data management method for making it possible to limit use of an image element.

### DISCLOSURE OF THE INVENTION

To accomplish the above-described object, an electronic file manipulation method according to a first aspect of the invention is a method used to manipulate an electronic file and includes a packaging step of packaging a selected file and at least one related file related to the file into a single file and an unpackaging step of unpackaging the package provided by packaging the files into the selected file and the related file.

To accomplish the above-described object, a program according to the first aspect of the invention is a program used to manipulate an electronic file and includes a packaging module for packaging a selected file and at least one related file related to the file into a single file and an unpackaging module for unpackaging the package provided by packaging the files into the selected file and the related file.

In the first aspect of the invention, the selected file and the file related to the file are packaged into a single file. Therefore, the later file manipulation can be facilitated. Moreover, packaging also containing the related file can be accomplished simply by selecting one file. The packaged files can be unpackaged into the original files. Consequently, the original files can be used for other purposes.

In the program according to the first aspect of the invention, the related file is, for example, a file stored in the folder associated with the file name of the selected file.

In the program according to the first aspect of the invention, the unpackaging module is a module for unpackaging the selected file in a specified folder, creating a folder associated with the file name of the selected file in the specified folder, and unpackaging the related file in the created folder, for example.

In the program according to the first aspect of the invention, the related file is, for example, a file determined by the storage position and the file name of the file described in the selected file.

In the program according to the first aspect of the invention, the unpackaging module is a module for unpackaging the selected file in a specified folder, unpackaging the related file in a predetermined folder, and rewriting the storage position of the related file described in the selected file as the file stored in the predetermined folder, for example.

To accomplish the above-described object, an electronic file manipulation method according to a second aspect of the invention is a method used to manipulate an electronic file and includes a packaging step of packaging a selected file and a file related to the file into a single file.

To accomplish the above-described object, a program according to the second aspect of the invention is a program used to manipulate an electronic file and includes a packaging module for packaging a selected file and a file related to the file into a single file.

In the second aspect of the invention, the selected file and the file related to the file are packaged into a single file. Therefore, the later file manipulation can be facilitated. Moreover, packaging also containing the related file can be accomplished simply by selecting one file.

To accomplish the above-described object, an electronic file manipulation method according to a third aspect of the invention is a method used to manipulate an electronic file and includes a file analysis step of analyzing a package file into which a selected file and a file related to the file are packaged as a single file, as the selected file and the file related to the file.

To accomplish the above-described object, a program according to the third aspect of the invention is a program used to manipulate an electronic file and includes a file analysis module for analyzing a package file into which a selected file and a file related to the file are packaged as a single file, as the selected file and the file related to the file.

In the third aspect of the invention, the package file is analyzed as the selected file and the related file before the files are packaged into the package file. Therefore, the package file can be handled like the files before being packaged into the package file.

To accomplish the above-described object, a layout edit apparatus according to a fourth aspect of the invention is a layout edit apparatus for editing a layout of an image area for displaying an image and includes layout edit means for placing at least one image and at least one merge image area into which an image can be merged and editing a layout; and file manipulation means for manipulating a file using the method according to the first aspect of the invention described above, wherein the file manipulation means is file manipulation means for adopting an information file containing information concerning placement of the image and the image area in the layout created and information concerning an image file used with the layout as the selected file and at least one file used with the layout as the related file.

In the layout edit apparatus according to the fourth aspect of the invention, files are manipulated using the program according to the first aspect of the invention. Therefore, simply by selecting the information file concerning the created layout, the files used with the layout can be packaged or unpackaged for executing file manipulation. Consequently, transfer of the files concerning the layout can be facilitated.

To accomplish the above-described object, a layout edit apparatus according to a fifth aspect of the invention is a layout edit apparatus for editing a layout of an image area for displaying an image and includes layout edit means for placing at least one image and at least one merge image area into which an image can be merged and editing a layout; and file output means for outputting an information file containing information concerning placement of the image and the image area in the layout created and information concerning an image file used with the layout and at least one file used with the layout as a single package file.

In the layout edit apparatus according to the fifth aspect of the invention, the information file concerning the created layout and the files used with the layout are output as a package file. Therefore, the created file can be saved in a single file. Consequently, transfer of the files concerning the layout can be facilitated.

Such a layout edit apparatus can also be provided with separation output means for separating the package file into the information file and the at least one file and outputting the files. In doing so, the package file can be separated into the files before being packaged.

To accomplish the above-described object, an image processing system according to a sixth aspect of the invention is an image processing system including an image output apparatus for outputting a digital image file and a layout definition file for defining a layout to display a digital image represented by the digital image file and an image display apparatus for displaying the digital image represented by the output digital image file based on the layout definition file, characterized in that the image output apparatus has packaging means for packaging the digital image file and the layout definition file into a single package file and output means for outputting the single package file, thereby outputting the digital image file and the layout definition file, and that the image display apparatus has input means for inputting the output package file and unpackaging means for acquiring the digital image file and the layout definition file from the input package file.

In the sixth aspect of the invention, the image display apparatus can acquire files from the package file, so that it is made possible for the image output apparatus to output the digital image file and the layout definition file as a package file. As the package file is output, for example, the time and labor for copying or attachment to electronic mail can be decreased in distributing and since only one file is to be copied, an error of forgetting about copying some files or the like can be prevented. Therefore, according to the image processing system, portability of the digital image file and the layout definition file can be improved.

Further, the image processing system according to the sixth aspect of the invention is characterized in that the image output apparatus further includes selection acceptance means for accepting selection of a digital image file and that the packaging means packages the digital image file selected through the selection acceptance means and the layout definition file previously related to the selected digital image file. According to the image processing system, in packaging, only the digital image file may be selected and the layout definition file need not be selected. Thus, the packaging time and labor can be decreased.

Further, the image processing system according to the sixth aspect of the invention is characterized in that the output means outputs a package file to removable memory and the input means inputs a package file from removable memory. According to the image processing system, removable memory can be used as a medium for transferring the package file.

Further, the image processing system according to the sixth aspect of the invention is characterized in that the output means outputs a digital image file and the package file into which the digital image file is packaged. For example, the person to whom a digital image file is to be distributed does not necessarily have an image display apparatus having unpackaging means. When the digital image file and the package file are output, the package file can be distributed to the person having an image display apparatus and thus portability can be improved. The digital image file not packaged can be distributed to the person having no image display apparatus.

Further, the image processing system according to the sixth aspect of the invention is characterized in that the output means transmits a package file to a communication line and the input means receives a package file from a communication line. According to the image processing system, the package file can be transferred via a communication line such as a serial cable, a LAN, or a telephone line, and the transferring time and labor can be decreased.

Further, the image processing system according to the sixth aspect of the invention is characterized in that the output means outputs a digital image file and the package file into which the digital image file is packaged.

To accomplish the above-described object, an image processing method according to a seventh aspect of the invention is an image processing method for transferring a digital image file and a layout definition file between an image output apparatus for outputting a digital image file and a layout definition file for defining a layout to display a digital image represented by the digital image file and an image display apparatus for displaying the digital image represented by the output digital image file based on the layout definition file, characterized by a packaging step of packaging the digital image file and the layout definition file into a single package file and an output step of outputting the single package file, thereby outputting the digital image file and the layout definition file in the image output apparatus; and an input step of inputting the output package file and an unpackaging step of acquiring the digital image file and the layout definition file from the input package file as unpackaging in the image display apparatus.

In the seventh aspect of the invention, the image display apparatus can acquire files from the package file, so that it is made possible for the image output apparatus to output the digital image file and the layout definition file as a package file. As the package file is output, for example, the time and labor for copying or attachment to electronic mail can be decreased in distributing and since only one file is to be copied, an error of forgetting about copying some files or the like can be prevented. Therefore, according to the image processing system, portability of the digital image file and the layout definition file can be improved.

To accomplish the above-described object, a layout edit method according to an eighth aspect of the invention is a layout edit method, characterized by a user interface step of accepting a command to edit a layout of an image element in a predetermined area on a screen; a layout edit step of editing a layout control file for controlling the layout of the image element based on the command accepted in the user interface step; and an output step of converting a content file representing all image elements laid out in the predetermined area and a layout control file for controlling the layout of all image elements laid out in the predetermined area into a single package file and outputting the package file.

To accomplish the above-described object, a layout edit program according to the eighth aspect of the invention is characterized in that the program causes a computer to function as user interface means for accepting a command to edit a layout of an image element in a predetermined area on a screen; layout edit means for editing a layout control file for controlling the layout of the image element based on the command accepted by the user interface means; and output means for converting a content file representing all image elements laid out in the predetermined area and a layout control file for controlling the layout of all image elements laid out in the predetermined area into a single package file and outputting the package file.

In the eighth aspect of the invention, a layout control file and the content file representing all image elements whose layout is controlled by the layout control file are converted into a single package file, whereby portability of information required for displaying a specific image element according to a specific layout can be improved. The content file representing all laid-out image elements and the layout control file for controlling the layout of all the image elements are specified without troubling the user, whereby the operability in the conversion operation to a single package file can be improved.

To accomplish the above-described object, a layout edit apparatus according to a ninth aspect of the invention is characterized by user interface means for accepting a command to edit a layout of an image element in a predetermined area on a screen; layout edit means for editing a layout control file for controlling the layout of the image element based on the command accepted by the user interface means; and output means for converting a content file representing all image elements laid out in the predetermined area and a layout control file for controlling the layout of all image elements laid out in the predetermined area into a single package file and outputting the package file.

In the ninth aspect of the invention, a layout control file and the content file representing all image elements whose layout is controlled by the layout control file are converted into a single package file, whereby portability of information required for displaying a specific image element according to a specific layout can be improved.

To accomplish the above-described object, a display data processing method according to a tenth aspect of the invention is characterized by a storage step of storing files making up a template; a selection step of selecting an image element to be merged into the template; and an output step of converting the files making up the template and a user file representing the image element selected in the selection step into a single file and outputting the file.

To accomplish the above-described object, a display data processing program according to the tenth aspect of the invention is characterized in that the program causes a computer to function as storage means for storing files making up a template; selection means for selecting an image element to be merged into the template; and output means for converting the files making up the template and a user file representing the image element selected in the selection step into a single file and outputting the file.

In the tenth aspect of the invention, the files making up the template and the user file representing the image element to be merged into the template are converted into a single package file, whereby portability of information required for merging the image element selected by the user into a predetermined template for display can be improved. The files making up the template are a file representing a predetermined image element, a file for controlling the layout of image elements, a file representing a thumbnail image representing the design of the template for causing the user to select the template, etc.

To accomplish the above-described object, a data processing apparatus according to an eleventh aspect of the invention is characterized by storage means for storing files making up a template; selection means for selecting an image element to be merged into the template; and output means for converting the files making up the template and a user file representing the image element selected by the selection means into a single file and outputting the file.

In the eleventh aspect of the invention, the files making up the template and the user file representing the image element to be merged into the template are converted into a single package file, whereby portability of information required for merging the image element selected by the user into a predetermined template for display can be improved.

To accomplish the above-described object, a display data processing method according to a twelfth aspect of the invention is characterized by a conversion step of converting a content file representing an image element and a layout control file for controlling a layout of the image element into a single package file; and a use limitation step of storing use limitation data to permit or inhibit individual use of content data contained in the package file representing the image element or layout control data contained in the package file for controlling the layout of the image element in the package file.

To accomplish the above-described object, a display data processing program according to the twelfth aspect of the invention is characterized in that the program causes a computer to function as conversion means for converting a content file representing an image element and a layout control file for controlling a layout of the image element into a single package file; and use limitation means for storing use limitation data to permit or inhibit individual use of content data contained in the package file representing the image element or layout control data contained in the package file for controlling the layout of the image element in the package file.

In the twelfth aspect of the invention, in the package file containing the content data representing the image element or the layout control data for controlling the layout of the image element, the use limitation data to permit or inhibit individual use of the data is stored, whereby, for example, use of the image element beyond the control of the layout control data or display of the image element under the control of the layout control data after the layout control data is edited can be inhibited as required.

Further, the display data processing program according to the twelfth aspect of the invention is characterized in that the use limitation data contains control data to remove the digital watermark added to the image element. The control data to remove the digital watermark is contained in the package file containing the content data representing the image element to which the digital watermark is added, whereby use of the image element can be limited so that the image element can be normally displayed only with a specific apparatus having a function of removing the digital watermark added to the image element based on the control data.

To accomplish the above-described object, a display data processing apparatus according to a thirteenth aspect of the invention is characterized by conversion means for converting a content file representing an image element and a layout control file for controlling a layout of the image element into a single package file; and use limitation means for storing use limitation data to permit or inhibit individual use of data contained in the package file representing the image element or data contained in the package file for controlling the layout of the image element in the package file.

In the thirteenth aspect of the invention, in the package file containing the content data representing the image element or the layout control data for controlling the layout of the image element, the use limitation data to permit or inhibit individual use of the data is stored, whereby, for example, use of the image element beyond the control of the layout control data or display of the image element under the control of the layout control data after the layout control data is edited can be inhibited as required.

To accomplish the above-described object, a display data processing method according to a fourteenth aspect of the invention is characterized by a display step of reading a package file storing content data representing an image element, layout control data for controlling a layout of the image element, and use limitation data and displaying the content data under the control of the layout control data; an individual use step of reading the package file and using the content data or the layout control data individually; and a management step of managing access to the package file and permitting or inhibiting the use in response to the use descriptions and the use limitation data.

To accomplish the above-described object, a display data processing program according to the fourteenth aspect of the invention is characterized in that the program causes a computer to function as display means for reading a package file storing content data representing an image element, layout control data for controlling a layout of the image element, and use limitation data and displaying the content data under the control of the layout control data; individual use means for reading the package file and using the content data or the layout control data individually; and management means for managing access to the package file and permitting or inhibiting the use in response to the use descriptions and the use limitation data.

In the fourteenth aspect of the invention, in the display data processing program using the package file storing the content data representing the image element, the layout control data for controlling the layout of the image element, and the use limitation data, the use is permitted or inhibited in response to the use descriptions and the use limitation data, whereby the user can be prevented from making use against the intention of the package file supplier. For example, use of the image element beyond the control of the layout control data or display of the image element under the control of the layout control data after the layout control data is edited can be inhibited as required.

Further, the display data processing program according to the fourteenth aspect of the invention is characterized in that the management means is responsive to the use limitation data for permitting or inhibiting the use of the content data beyond the control of the layout control data by the individual use means. The use of the content data beyond the control of the layout control data is inhibited as required, whereby, for example, the content data which may be used only if it is displayed in a specific layout can be prevented from being redistributed in a state in which the content data is separated from the layout control data.

Further, the display data processing program according to the fourteenth aspect of the invention is characterized in that the management means is responsive to the use limitation data for permitting or inhibiting the use of editing the layout control data by the individual use means. Editing the layout control data is inhibited as required, whereby the content data which may be used only if it is displayed in a specific layout can be prevented from being displayed in any other layout than the specific layout.

Further, the display data processing program according to the fourteenth aspect of the invention is characterized in that the management means is responsive to the use limitation data for permitting or inhibiting the use of storing the content data in nonvolatile memory as a single body by the individual use means. Storing the content data in nonvolatile memory as a single body is inhibited as required, whereby the content data which may be used only if it is displayed in a specific layout can be prevented from being used by a different program or being redistributed in a state in which the content data is separated from the layout control data.

Further, the display data processing program according to the fourteenth aspect of the invention is characterized in that the program causes a computer to function as means for removing the digital watermark added to the image element represented by the content data. A digital watermark is added to the image element to be used by the display data processing program, whereby illegal use of the image element by a program not intended for using the image element can be prevented.

To accomplish the above-described object, a display data processing apparatus according to a fifteenth aspect of the invention is characterized by display means for reading a package file storing content data representing an image element, layout control data for controlling a layout of the image element, and use limitation data and displaying the content data under the control of the layout control data; individual use means for reading the package file and using the content data or the layout control data individually; and management means for managing access to the package file and permitting or inhibiting the use in response to the use descriptions and the use limitation data. In the display data processing apparatus using the package file storing the content data representing the image element, the layout control data for controlling the layout of the image element, and the use limitation data, the use is permitted or inhibited in response to the use descriptions and the use limitation data, whereby the user can be prevented from making use against the intention of the package file supplier.

To accomplish the above-described object, a file data structure according to a sixteenth aspect of the invention is characterized by a first area in which content data representing an image element is recorded; a second area in which layout control data for controlling a layout of the image element is recorded; and a third area in which use limitation data to limit use of the content data or the layout control data is recorded. Together with the content data representing an image element and the layout control data for controlling the layout of the image element, the use limitation data to limit the use of the data is recorded in one file, whereby use of the image element beyond the control of the layout control data or display of the image element under the control of the layout control data after the layout control data is edited in the program using the file can be inhibited as required.

The file data structure according to the sixteenth aspect of the invention is characterized in that an image element to which a digital watermark is added is recorded in the first area and that the use limitation data containing control data to remove the digital watermark is recorded in the second area. A digital watermark and the control data to remove the digital watermark are added to an image element so that only the display data processing program guaranteed for appropriate use of the image element is allowed to remove the digital watermark, whereby illegal use of the image element can be prevented.

To accomplish the above-described object, a display data management method according to a seventeenth aspect of the invention is characterized by the steps of distributing a package file recording content data representing an image element, layout control data for controlling a layout of the image element, and use limitation data to a reception terminal through a network; storing identification information proper to the reception terminal in the package file in response to distribution of the package file; and making a comparison between information proper to a use terminal and the identification information stored in the package file and permitting or inhibiting use of the content data or the layout control data contained in the package file by the use terminal in response to the comparison result. The identification information proper to the reception terminal is stored in the package file in response to distribution of the package file and when the package file is used, use of the package file is permitted or inhibited in response to the comparison result between the information proper to the use terminal and the identification information stored in the package file, so that the user not having the use right of the package file can be prevented from using the package file.

The functions of the plurality of means included in the invention are provided by hardware resources whose functions are determined by the configuration, hardware resources whose functions are determined by programs, or a combination thereof. The functions of the plurality of means are not limited to those provided by hardware resources physically independent of each other.

### BRIEF DESCRIPTION OF THE DRAWINGS

FIG. 1 is a flowchart to show an example of packaging processing in a file manipulation program of an embodiment.

FIG. 2 is a schematic representation to show an example of a packaging command screen 10.

FIG. 3 is a schematic representation to show an example of a file selection screen 11.

FIG. 4 is a schematic representation to show an example of a main file and related files to which packaging processing is applied.

FIG. 5 is a schematic representation to show an example of a file created by performing the packaging processing;

FIG. 6 is a flowchart to show an example of unpackaging processing in the file manipulation program of the embodiment.

FIG. 7 is a schematic representation to show an example of a package file to which unpackaging processing is applied.

FIG. 8 is a schematic representation to show an example of an unpackaging command screen 12.

FIG. 9 is a schematic representation to show an example of a file created by performing the unpackaging processing.

FIG. 10 is a drawing to show an outline of the configuration of a print system including a layout edit apparatus 20 of the embodiment of the invention.

FIG. 11 is a flowchart to show an example of the main routine executed by the layout edit apparatus 20 of the embodiment.

FIG. 12 is a schematic representation to show an example of a paper setting screen 30.

FIG. 13 is a schematic representation to show an example of a layout work screen 40 and a tool box screen 50.

FIG. 14 is a schematic representation to show the layout work screen 40 and the tool box screen 50 when merge photo frames 71 and 72 and a frame image 73 are set.

FIG. 15 is a schematic representation to show an example of a pull-down menu 46.

FIG. 16 is a schematic representation to show an example of files created in a storage section 26 of the layout edit apparatus 20 when a layout is saved according to the “usual save.”

FIG. 17 is a schematic representation to show an example of a script file, a thumbnail file, and an image file in a modification.

FIG. 18 is a schematic representation to show an example of the descriptions of the script file in the modification.

FIG. 19 is a schematic representation to show examples of selected file and related files.

FIG. 20 is a schematic representation to show examples of selected file and related files.

FIG. 21 is a schematic drawing to show an image processing system according to a first embodiment of the invention.

FIG. 22 is a block diagram to show the configuration of an image output apparatus.

FIG. 23 (A) is a front view of the image output apparatus and FIG. 23 (B) is a rear view of the image output apparatus.

FIG. 24 (A) is a perspective view of an image display apparatus and FIG. 24 (B) is a drawing to show a display and an operation section on an enlarged scale.

FIG. 25 is a block diagram of the image display apparatus.

FIG. 26 is a schematic drawing to show a directory structure in removable memory.

FIG. 27 is a schematic drawing to show the contents of a layout definition file.

FIG. 28 (A) is a schematic drawing to describe display using the layout definition file and FIG. 28 (B) is a plan view to show the display result.

FIG. 29 is a drawing to show the format of a package file.

FIG. 30 (A) is a drawing to show the format of “0th IFD” and FIG. 30 (B) is a drawing to show the format of “1th IFD.”

FIG. 31 (C) is a drawing to show the format of “2th IFD” and FIG. 31 (D) is a drawing to show the format of “3th IFD.”

FIG. 32 (E) is a drawing to show the format of “4th IFD.”

FIG. 33 is a flowchart to show a processing flow of an image output apparatus.

FIG. 34 (A) is a screen to accept selection of a layout definition file and FIG. 34 (B) is a screen to accept selection of a digital image file.

FIG. 35 is a flowchart to show a processing flow of an image display apparatus.

FIG. 36 is a screen to accept selection of a digital image file.

FIG. 37 is a schematic drawing to show an image processing system according to a third embodiment.

FIG. 38 is a data structure drawing of a package file according to a fourth embodiment.

FIG. 39 is a flowchart to show a flow of management processing of the use of a package file by a display data processing program.

FIG. 40 is a sequence chart to describe a display data management method of a sixth embodiment.

FIG. 41 is a flowchart to show a flow of processing of merging a user image into a template for display in a user terminal.

### BEST MODE FOR CARRYING OUT THE INVENTION

Next, embodiments of the invention will be discussed using embodiments.

### FIRST EMBODIMENT

A file manipulation program as a first embodiment of the invention is a program concerning file manipulation in a computer and is made up of a packaging module for packaging a plurality of files and an unpackaging module for unpackaging a packaged file.

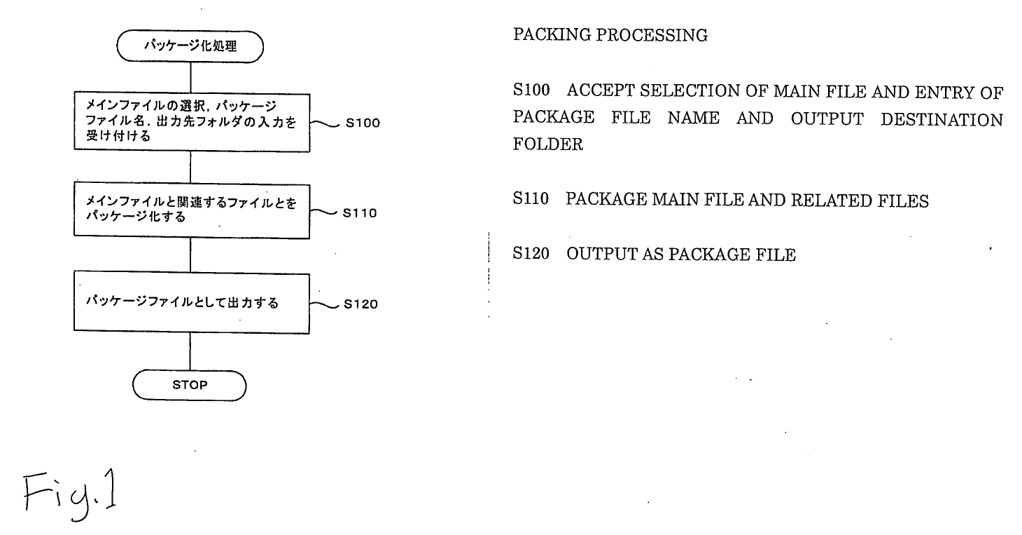

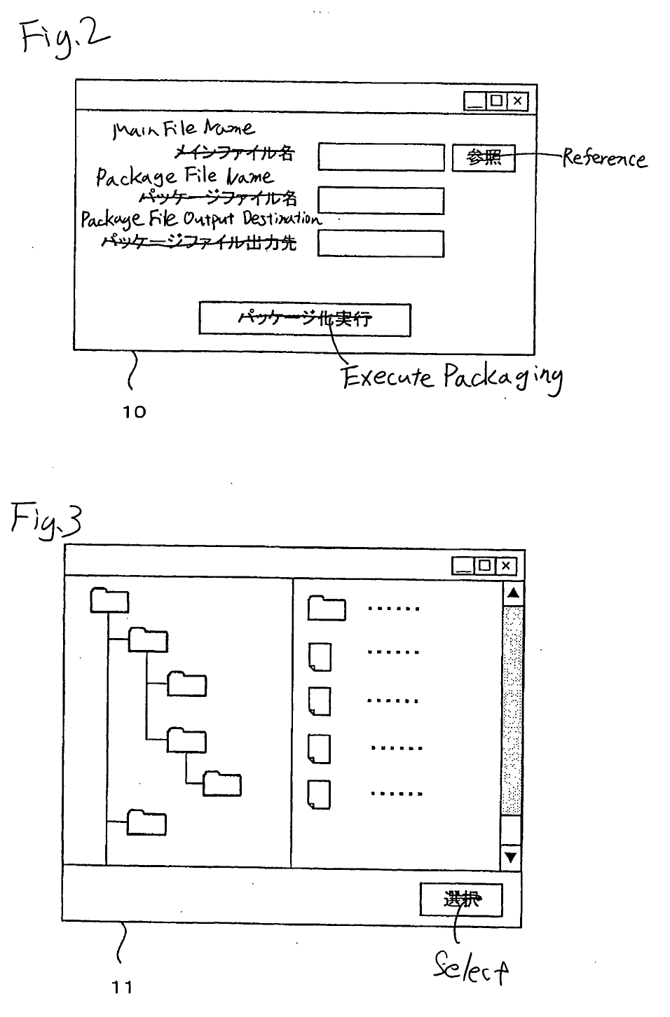

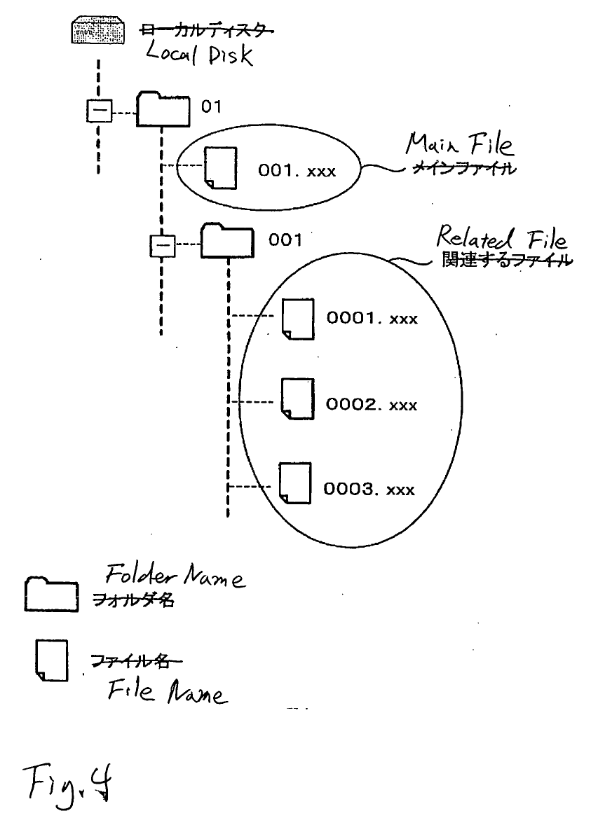

FIG. 1 is a flowchart to show an example of packaging processing in the file manipulation program of the first embodiment. In the packaging processing, first, selection of a main file and entry of the name of a package file, the output destination folder, etc., are accepted (step S100). The main file is a file to specify other related files to be packaged. The specification method is described later. In the first embodiment, selection of a main file, etc., is accepted through a packaging command screen. FIG. 2 shows an example of a packaging command screen 10. The packaging command screen 10 enables the user to enter the main file name, the package file name, and the package file output destination, as shown in the figure. When the main file name is entered, the name having package file extension (for example, “.pkg”) added to the main file name is automatically entered in the package file name, the name of the folder in which the main file exists is automatically entered in the package file output destination, and the automatic entry can be directly corrected. The main file name can be entered through a file selection screen 11 output as a “reference” button to the right of an input field is pressed. On the file selection screen 11 illustrated in FIG. 3, if one of folders displayed in a tree structure on the left of the screen is selected, the files existing in the selected folder are listed on the right of the screen and the main file can be selected from among the listed files.

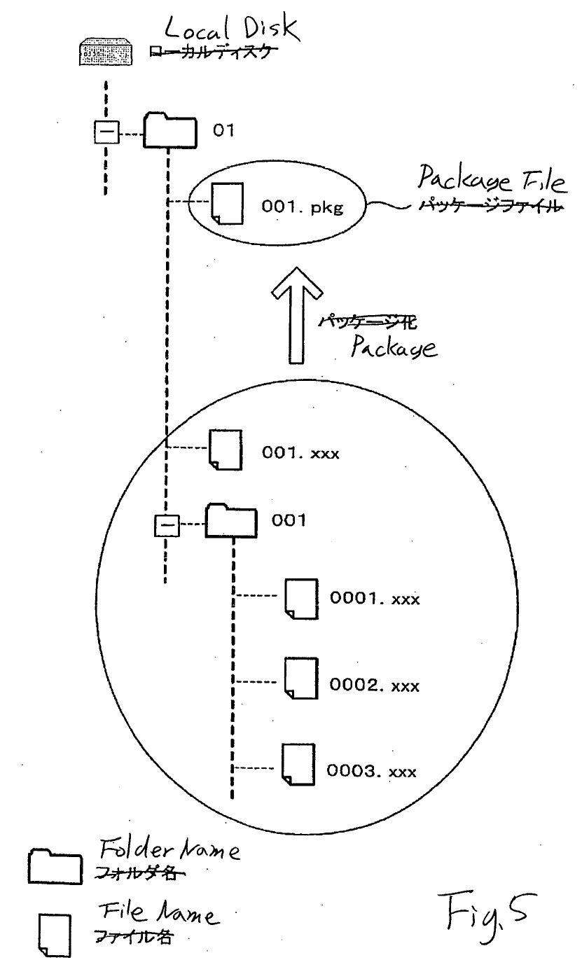

Next, the selected main file and the files related to the main file are packaged (step S110). In the first embodiment, the files in the folder of the same name as the main file existing in the same folder as the main file are packaged. As illustrated in FIG. 4, if file “001.xxx” is selected as the main file, files “0001.xxx” to “0003.xxx” in folder “001” of the same name as the main file existing in the same folder “01” are packaged as related files.

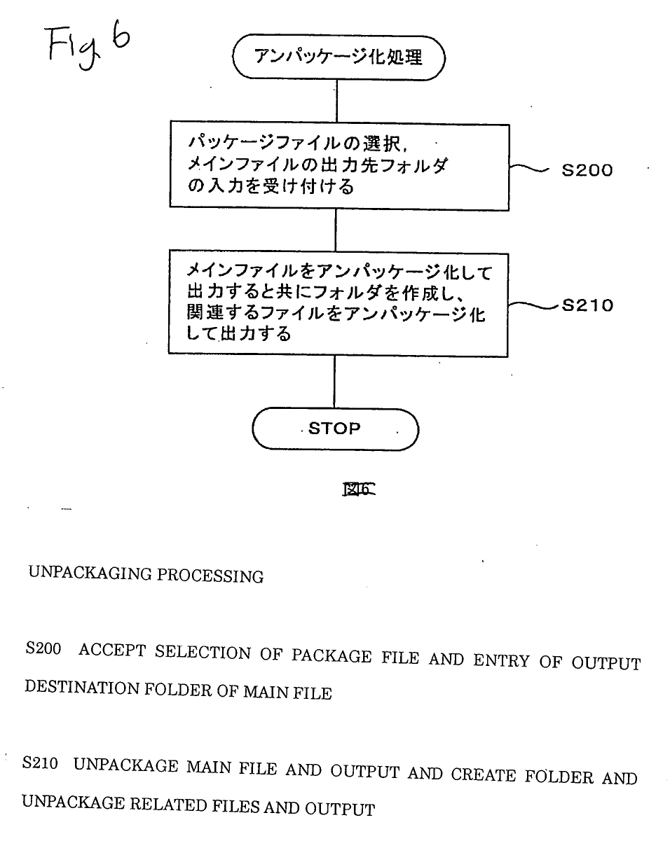

When the files are thus packaged, the packaged files are output as a package file and the packaging processing is terminated (step S120). In the embodiment, the package file is output based on the name and the output destination folder entered at step S100. FIG. 5 is a schematic representation to show the output result of the package file when the entered name is “001.pkg” and the output destination folder is “01.” The package file may be output as a file subjected to data compression processing by a data compression method such as Run-Length coding or Huffman coding.

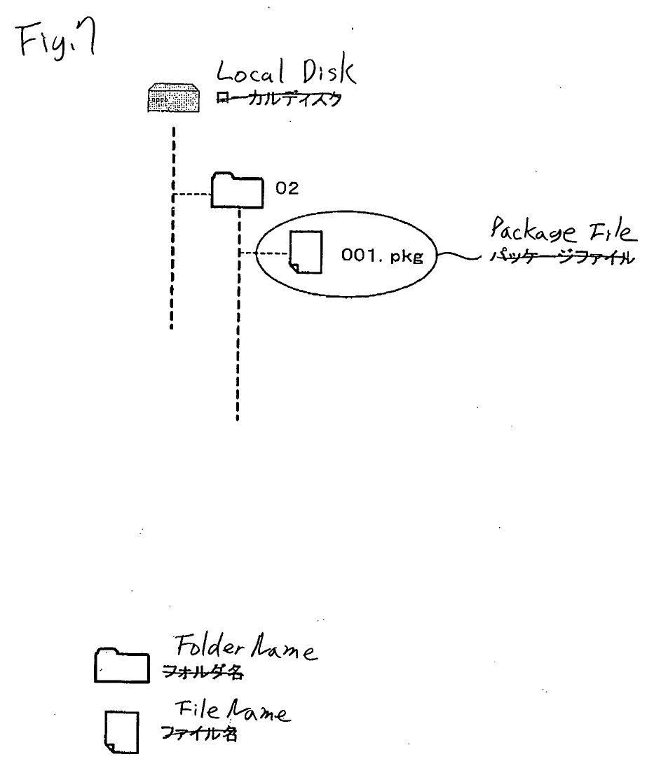

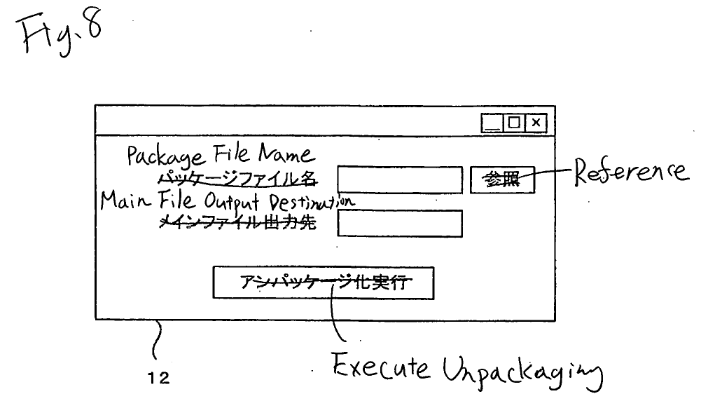

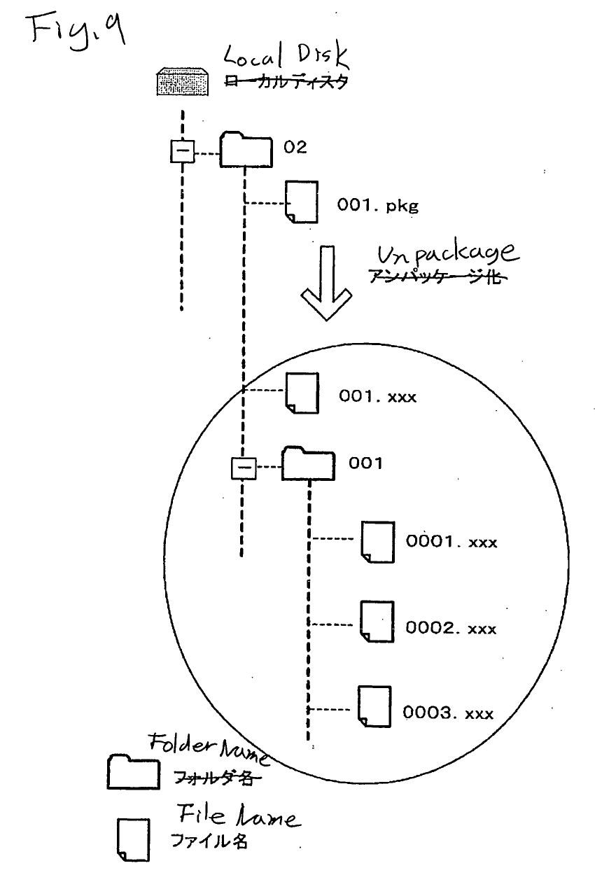

FIG. 6 is a flowchart to show an example of unpackaging processing in the file manipulation program of the first embodiment. In the first embodiment, the case where the package file “001.pkg” output by performing the packaging processing described above is copied into folder “02” and is unpackaged as illustrated in FIG. 7 will be discussed as a specific example. In the unpackaging processing, first, selection of the package file to be unpackaged and entry of the output destination folder of the main file are accepted (step S200) as shown in FIG. 6. In the first embodiment, entry such as selection of the package file, etc., is accepted through an unpackaging command screen. An unpackaging command screen 12 illustrated in FIG. 8 enables the user to enter the package file name and the main file output destination. When the package file name is entered, the name of the folder in which the package file exists is automatically entered in the main file output destination, and the automatic entry can also be corrected. The package file name can be entered through the file selection screen 11 output as a “reference” button to the right of an input field is pressed as with the packaging command screen 10 described above. In the specific example, the package file “001.pkg” is selected as the package file to be unpackaged and the folder “02” is entered as the main file output destination.

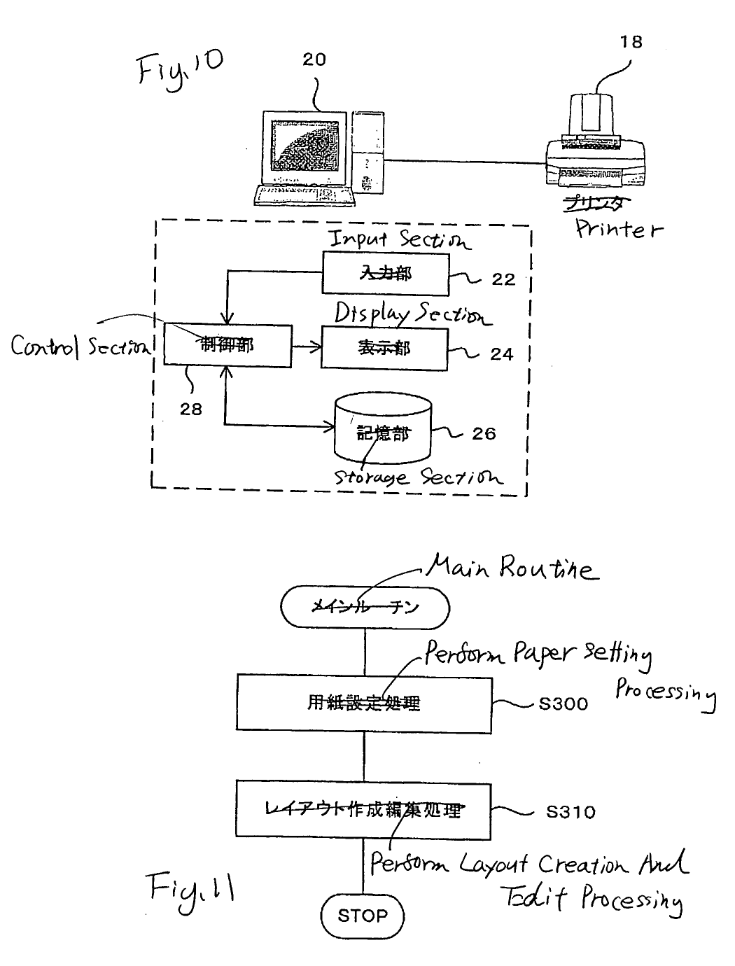

Next, the selected package file is unpackaged and the unpackaging processing is terminated (step S210). In the first embodiment, the main file is unpackaged and is output to the output destination folder entered at step S200 and in the same folder, a folder of the same name as the name of the main file is created and the related files contained in the package file are unpackaged and are output to the created folder. FIG. 9 is a schematic representation to show a file created by performing the unpackaging processing in the specific example. As shown in the figure, the main file “001.xxx” contained in the package file “001.pkg” is unpackaged and is output to the output destination folder “02” and folder “001” of the same name as the main file is created. The related files “0001.xxx” to “0003.xxx” are unpackaged and are output to the folder “001.”

According to the described file manipulation program, a plurality of electronic files can be packaged and be output as a package file for facilitating the later file manipulation. Moreover, easy packaging also including the related files can be accomplished simply by selecting the main file. The packaged files can be unpackaged and restored to the original files for use.

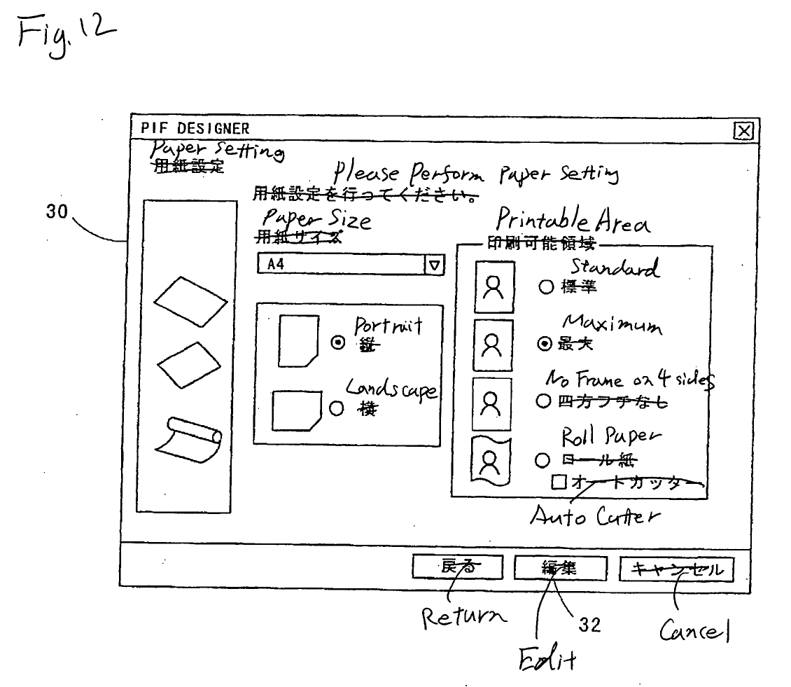

Next, the case where the file manipulation program of the first embodiment is built in file manipulation processing of a layout edit apparatus 20 will be discussed. FIG. 10 is a drawing to show an outline of the configuration of a print system including the layout edit apparatus 20. The layout edit apparatus 20 of the first embodiment is implemented as a general-purpose personal computer in which a layout edit program for editing the layout of an image area to print an image and creating a so-called template is installed.

The layout edit apparatus 20 includes an input section 22 for entering a command from the user through an input device such as a keyboard or a mouse, a display section 24 as a display, a storage section 26 for storing data of a program, an image, etc., and a control section 28 for performing predetermined operations and controlling the whole. The commands entered by the user through the input section 22 include, for example, a command to edit the layout of image elements and specifically, for example, commands to specify the placement position and size of each image element and to select an image element. The input section 22 accepts the commands through the keyboard and the mouse. A printer 18 is connected to the layout edit apparatus 20 of the first embodiment. The printer 18 prints a laid-out image, etc., on print paper based on a print command from the personal computer functioning as the layout edit apparatus 20.

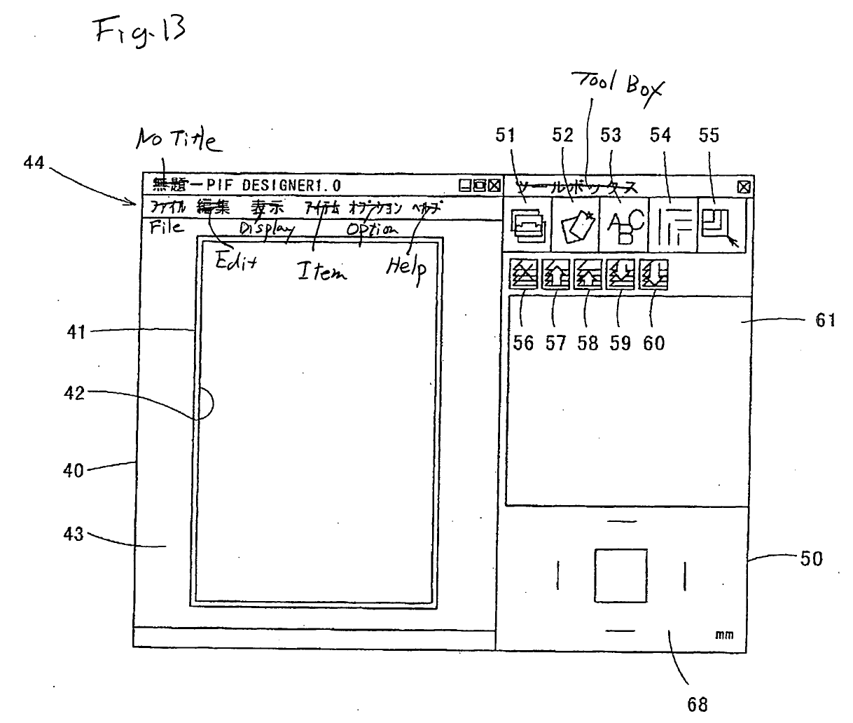

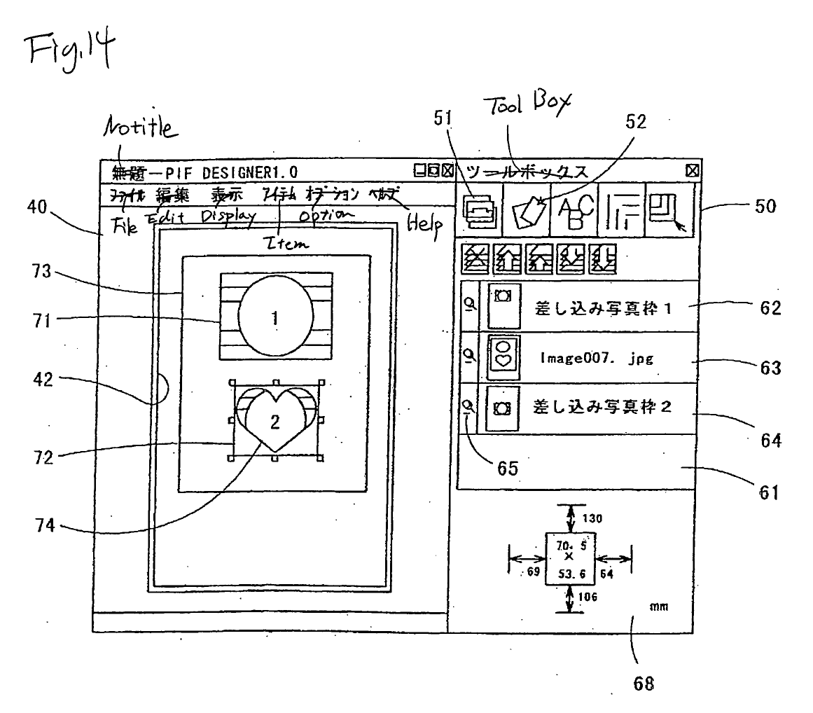

FIG. 11 is a flowchart to show an example of the main routine executed by the layout edit apparatus 20 of the first embodiment. This processing is processing when the layout edit program is executed by the personal computer. In the layout edit apparatus 20 of the first embodiment, first, setting processing of the paper size, paper orientation, printable area, etc., is executed using a paper setting screen 30 illustrated in FIG. 12 (step S300). In the example in FIG. 12, the paper size can be selected using a pull-down menu and “portrait” or “landscape” can be selected as the paper orientation using a selective button. The printable area can be selected from among “standard” for setting standard frame (margins) in four sides, “maximum” for setting the maximum printable area, and “no frame on four sides” for making frameless print possible. In “no frame on four sides,” a margin of a minus value is set so as to prevent a slight margin from occurring with a paper position shift at the printing time. When “roll paper” is selected as the paper size, “auto cutter” for automatically cutting paper at the print completion can also be set.

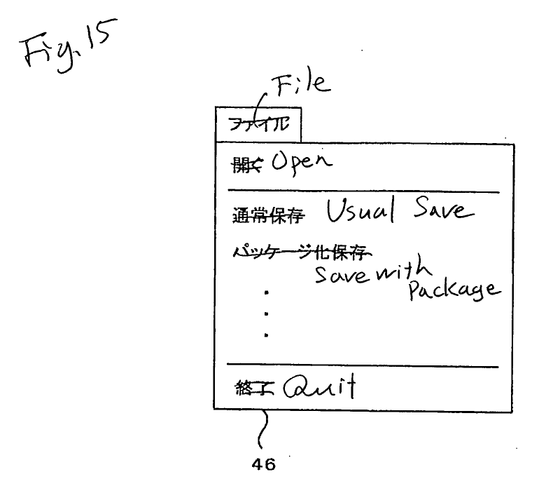

When settings are thus selected on the paper setting screen 30 and an edit button 32 is selected, layout edit processing is executed using a layout work screen 40 and a tool box screen 50 illustrated in FIG. 13 (step S310). The layout work screen 40 illustrated in FIG. 13 displays a work area displaying a paper area 41 and a printable area 42 and a tool bar 44 for selecting with a pull-down menu to perform file manipulation, editing, etc. The printable area 42 is an area for laying out on the screen the image elements laid out on one page corresponding to a predetermined print paper size. The image elements laid out in the printable area 42 include a photo image, a background image of a photo image, a frame, a decoration, a character string, a line, a curve, etc. The tool box screen 50 displays various buttons 51 to 60 for performing various operations in the printable area 42 of the layout work screen 40, an image area display operation section 61 for displaying the order and display and non-display of the layers of image areas displayed in the printable area 42, and a position information display section 68 for displaying position information relative to the printable area 42, of the selected image area among the image areas set in the printable area 42 of the layout work screen 40. The buttons displayed on the tool box screen 50 are a merge photo frame button 51 for setting an image area into which an image such as a photo can be merged, a background, frame, ornamental frame button 52 for setting an image area to read an image and create a background, a frame, a decoration, etc., of an image such as a photo, a character string button 53 for setting an area to enter a character string, a line button 54 for drawing a line, a selection button 55 for selecting an image area, a deletion button 56 for deleting the selected image area, a forefront button 57 for moving the selected image area to the forefront layer, a front button 58 for moving the selected image area to the just preceding front layer, a rearmost button 59 for moving the selected image area to the rearmost layer, and a rear button 60 for moving the selected image area to the just following rear layer.

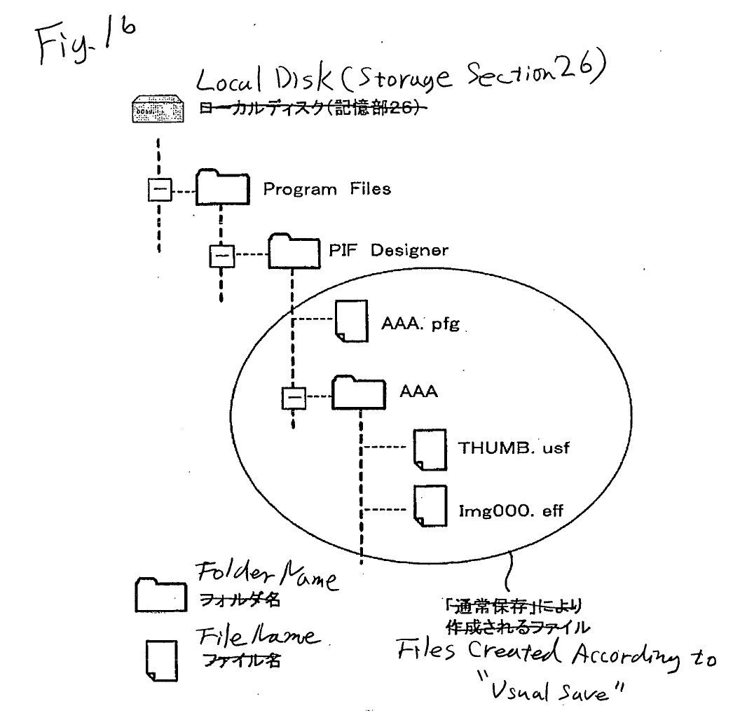

FIG. 14 shows the layout work screen 40 and the tool box screen 50 when merge photo frames 71 and 72 are set using the merge photo frame button 51 and a frame image 73 is set using the background, frame, ornamental frame button 52.

When the background, frame, ornamental frame button 52 is clicked, it is made possible to set a rectangular area in the printable area 42 by dragging in the printable area 42. When a rectangular area is thus set, a screen not shown to select a file as a content file representing an image element allocated to the rectangular area is displayed. When a file representing any desired image element is selected on the screen, the image element is displayed in the previously setup rectangular area and the path of the selected file is temporarily stored in RAM, etc. The display data maybe essential data or may be thumbnail data. The temporarily stored path of the file is referenced when the layout being edited is saved, and the file representing all image elements laid out in the printable area 42 is saved in a predetermined directory together with a script file for controlling the layout. Of course, the real body of the file rather than the path may be temporarily stored.

As shown in the figure, the merge photo frames 71 and 72 and the frame image 73 are displayed on the layout work screen 40, an operation button 62 of merge photo frame 1 corresponding to the merge photo frame 71 as an image area set in the printable area 42 of the layout work screen 40, an operation button 63 of “Image007.jpg” corresponding to the frame image 73, and an operation button 64 of merge photo frame 2 corresponding to the merge photo frame 72 are displayed from the top in order starting at the upper layer in the image area display operation section 61 of the tool box screen 50, and the position of the image area selected in the printable area 42 of the layout work screen 40 (in FIG. 4, the merge photo frame 72) within the printable area 42 is displayed in the position information display section 68. A heart-shaped transparent area 74 is set in the frame image 73 set in the printable area 42 of the layout work screen 40, and the corresponding portion of the merge photo frame 72 on the lower layer is seen through the setup transparent area 74.

The layout edit processing in the layout edit apparatus 20 of the first embodiment has been described. File manipulation processing in which the file manipulation program of the first embodiment is built will be discussed. The file manipulation processing is made up of layout save processing of saving a created layout and layout read processing of reading a saved layout. First, the layout save processing will be discussed and then the layout read processing will be discussed.

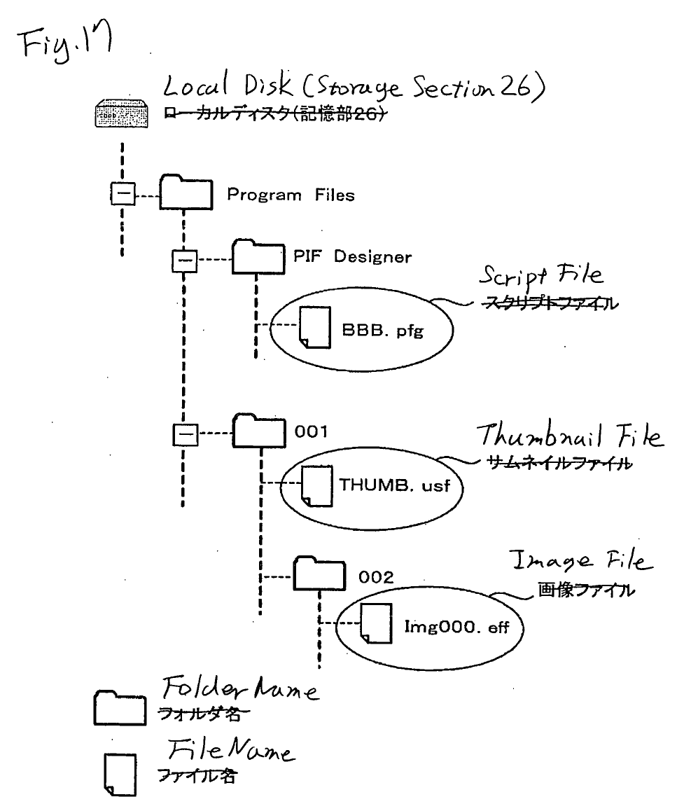

The layout save processing is executed as “usual save” or “save with packaging” is selected using a pull-down menu 46 illustrated in FIG. 15. The pull-down menu 46 is displayed as a “file” menu of the tool bar 44 on the layout work screen 40 is selected. The “usual save” is a save mode for creating a script file as a layout control file describing information set in the creation and edit processing of a layout in a text format, image files as content files corresponding to all image elements of the photo image, background, frame, decoration, character string, line, curve, etc., laid out in the printable area, and a thumbnail file for displaying the whole image of the layout on a reduced scale and saving the files. The “save with packaging” is a save mode for outputting the files created in the “usual save” as a package file by executing the packaging processing of the file manipulation program of the first embodiment.

When the layout is saved with the “usual save” selected, a script file for controlling the print layout corresponding to the layout on the screen is created in the specified folder, a folder of the same name as the script file is created, and a thumbnail file and an image file are created in the created folder. FIG. 16 is a schematic representation to show an example of files created in the storage section 26 of the layout edit apparatus 20 when the layout is saved according to the “usual save.” As shown in the figure, a script file “AAA.pfg” is created in a specified folder “PIF Designer,” in the same folder, a folder “AAA” of the same name as the script file is created, and further a thumbnail file “THUMB.usf” and an image file “Img000.eff” are created in the folder “AAA.”

One or two or more files representing all image elements of the photo image, background, frame, decoration, character string, line, curve, etc., laid out in the printable area are created in the folder “AAA.” The files include copies of a file representing a photo image and a file representing a background image previously stored in addition to the files created by the layout edit program. The previously stored files are files with the paths temporarily stored during the layout edit work as described above. When the layout is saved, a copy of the file indicated by the stored path is saved in the folder “AAA.”

On the other hand, when the layout is saved with the “save with packaging” selected, a script file, a thumbnail file, and an image file are created as with the “usual save” and then the packaging processing of the file manipulation program of the first embodiment described above is executed with the script file as the main file. That is, if the script file is used as the main file, the files existing in the folder “AAA” of the same name as the script file name in the same folder as the script file “AAA.pfg” (thumbnail file “THUMB.usf” and image file “Img000.eff”) become files related to the main file as seen from a comparison between FIGS. 4 and 16. Therefore, the script file is selected and packaging processing is executed, whereby the script file, the thumbnail file, and the image file can be packaged and output as a package file.

When the “save with packaging” is specified, all files saved with the “usual save” as for the layout edited at the point in time may be created and the created files may be converted into a single package file. That is, one package file containing data representing all image elements laid out in the printable area 42 when the “save with package” is specified and data to control the layout of the image elements can also be created automatically without making the user select a script file.

With the “save with packaging,” after the package file is output, the script file, the thumbnail file; and the image file may be deleted automatically. The script file, the thumbnail file, and the image file may be created virtually in memory and only a package file may be output based on the virtually created files.

The layout read processing is executed as “open” is selected using the pull-down menu 46 described above and the script file or the package file created in the layout save processing is specified. To execute the layout read processing with the script file specified, the thumbnail file and the image file are read together with the specified script file as they are, and the layout edit processing is made possible.

On the other hand, to execute the layout read processing with the package file specified, the script file, the thumbnail file, and the image file contained in the package file are analyzed using the unpackaging module of the file manipulation program of the first embodiment described above. The analyzed files are created virtually in memory and the layout is read. In this case, the script file, the thumbnail file, and the image file are not output, but the files can be output by saving the layout according to the “usual save” described above.

According to the layout edit apparatus 20 of the first embodiment described above, the file manipulation program of the first embodiment is applied to the file manipulation processing, so that it can be made easy to save and transfer files concerning the layout.

In the layout edit apparatus 20 of the first embodiment, the layout save processing is executed with “usual save” or “save with packaging” selected using the pull-down menu 46, but the layout may always be saved according to the “save with packaging” without executing the “usual save.”

In the layout edit apparatus 20 of the first embodiment, to execute the layout read processing with the package file specified, the script file, the thumbnail file, and the image file contained in the package file are analyzed, but the unpackaging processing of the file manipulation program of the first embodiment may be applied as it is. That is, the script file, the thumbnail file, and the image file contained in the package file may be unpackaged and output and the output files may be read.

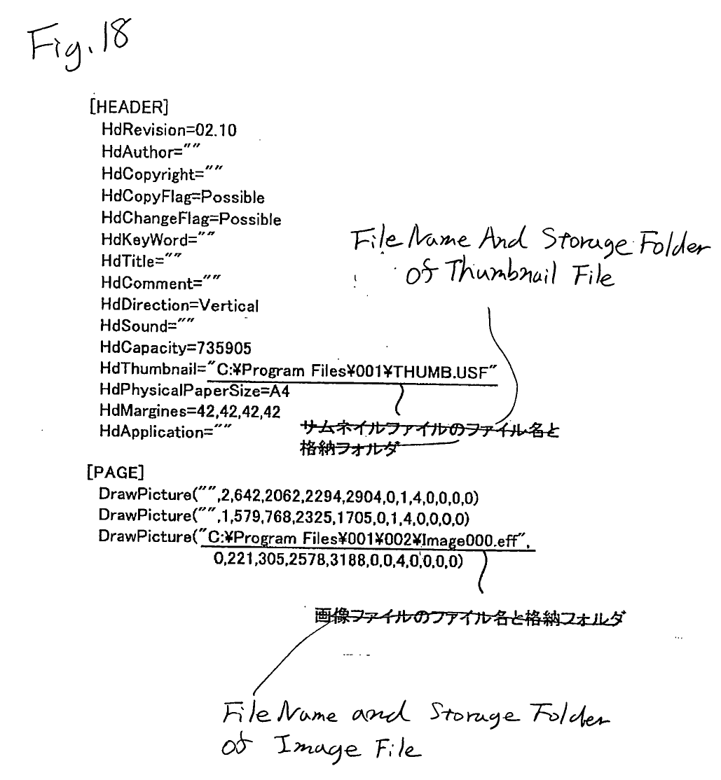

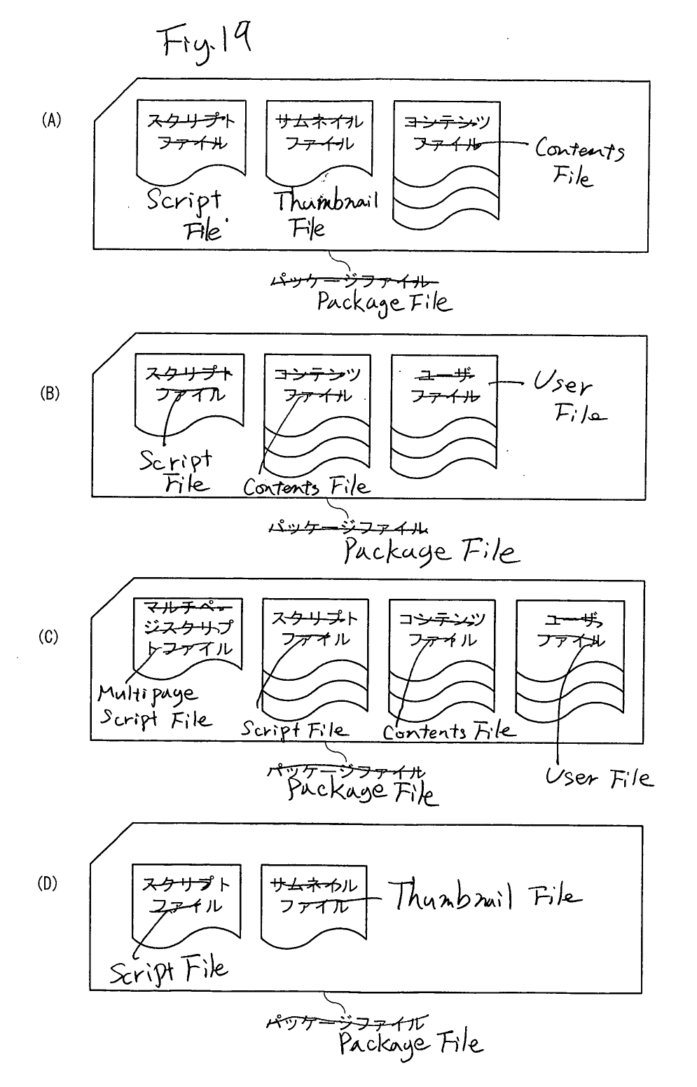

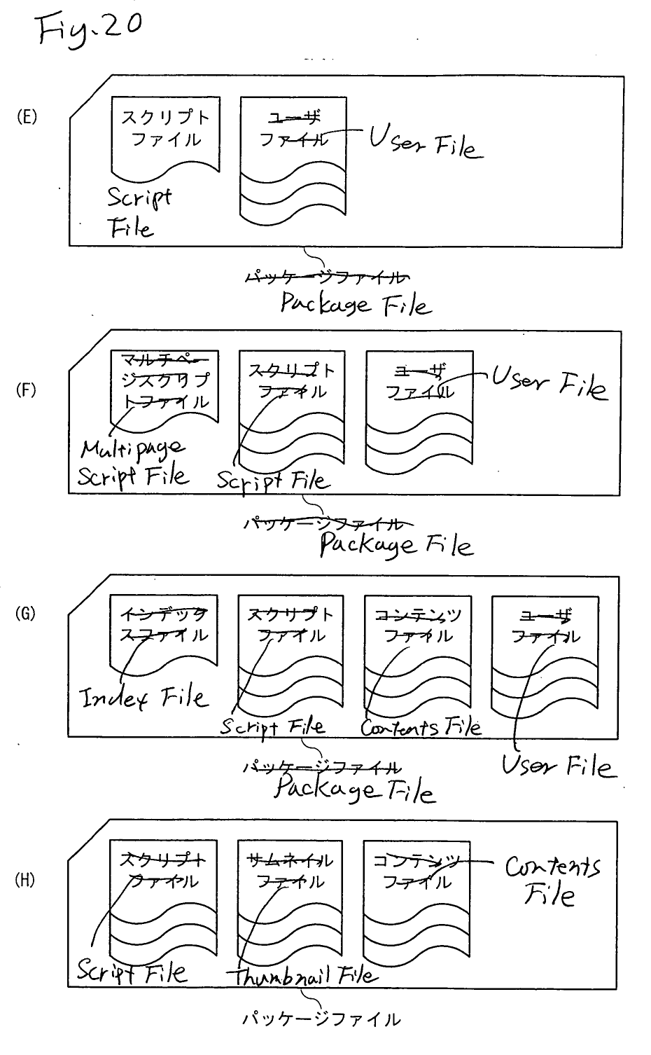

In the file manipulation program of the first embodiment, the files in the folder of the same name as the main file are packaged as the related files, but the related files may be able to be specified from the main file and the files described in the main file may be packaged as the related files. For example, the files whose position and name are described in the main file in a text format may be packaged as the related files. To unpackage the package file provided by packaging the files in such a manner, the related files may be unpackaged and output to predetermined positions and the positions of the related files described in the main file may be rewritten with the actual output positions. Such a file manipulation program can also be applied to the file manipulation processing of the layout edit apparatus 20 of the first embodiment. That is, to apply save with packaging to the layout made up of a script file “BBB.pfg, ” a thumbnail file “THUMB.usf,” and an image file “Img000.eff” illustrated in FIG. 17, the descriptions of the script file “BBB.pfg” (file names and storage folders of the thumbnail file and the image file) illustrated in FIG. 18 may be referenced, the thumbnail file and the image file may be specified, and a package file may be output. To unpackage the package file, the descriptions of the script file “BBB.pfg” may be rewritten with the folders into which the thumbnail file and the image file are actually output.

The file manipulation program of the first embodiment is made up of the packaging module and the unpackaging module, but may be implemented as only the packaging module. It may be implemented as only an analysis module for analyzing a package file and handling the package file as files before being packaged.

The case where the file manipulation program of the first embodiment is built in the file manipulation processing of the layout edit apparatus 20 has been described as an application example, but the file manipulation program can also be applied to other apparatus for packaging a plurality of files into a single file and unpackaging the packaged files for use. For example, the file manipulation program can also be applied to a file distribution apparatus for distributing a plurality of files to client computers connected through a network and a printer for printing the layout created in the layout edit apparatus 20 of the first embodiment.

In an apparatus for producing print display or screen display of a photo image using the layout created in the layout edit apparatus 20 as a template, the file manipulation program of the invention may be applied to a program for converting a file selected by the user as a user file representing a photo image merged into the merge photo frame of the template, the script file of the template, and a file representing an image element into one package file. In this case, the package file corresponding to the template and a user file representing a photo image, etc., to be merged into the template may be converted into a new package file.

In the description, the file manipulation program of the first embodiment is assumed to package a script file, one thumbnail file, and one image file, but the combination of the files to be packaged into one file may be any other than described above.

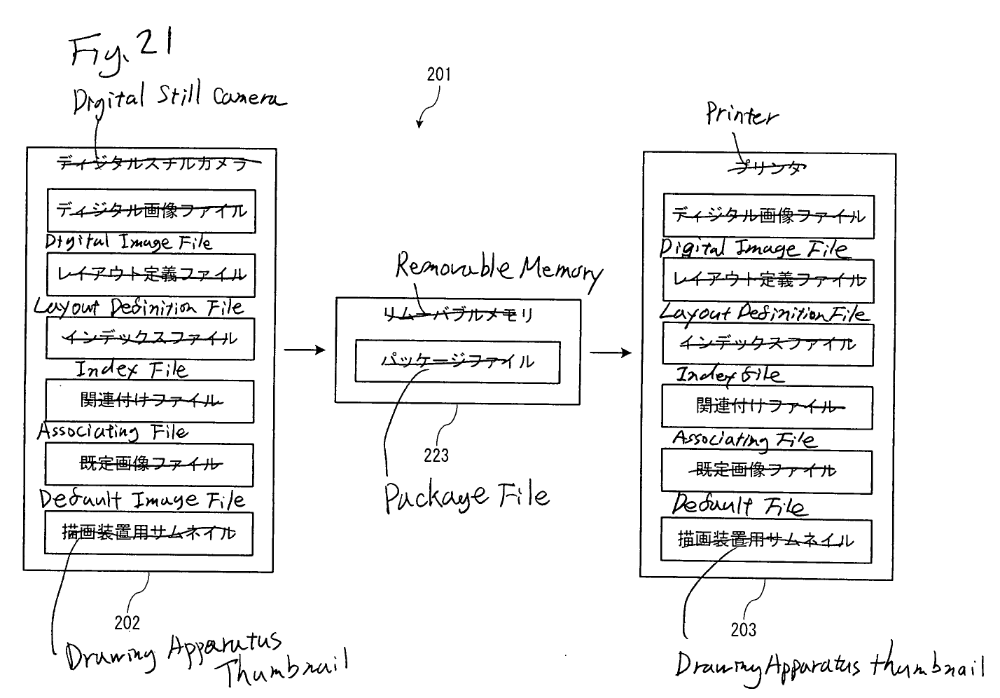

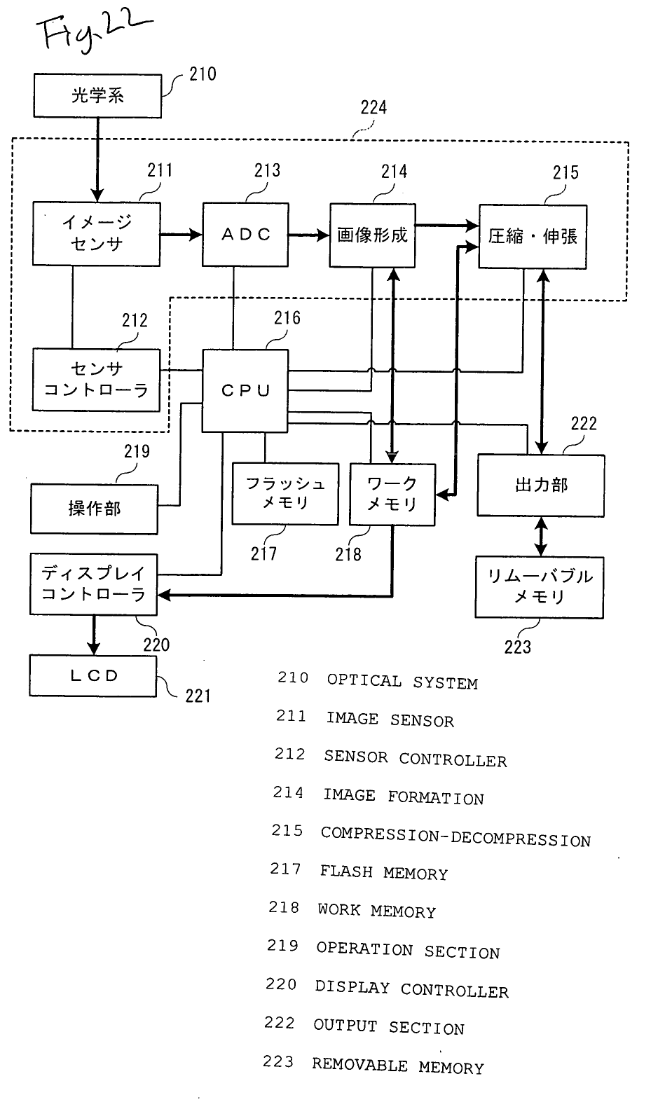

FIGS. 19 and 20 are schematic drawings to describe various uses of the file manipulation program.

For example, the number of image files to be packaged may be more than one.

FIG. 19 (A) shows an example of packaging a script file, a thumbnail file, and a plurality of image files into one file. A plurality of files representing image elements (content files) can be placed in the template defined by the script file. Thus, a plurality of content files may be related to one script file. If it is made possible to package a plurality of content files into one package file, handling when there are a plurality of image files laid out for the template can be facilitated.

For example, a template and information representing the image element to be merged into the template can be packaged into one file.

FIG. 19 (B) is a schematic drawing to show an example of packaging files making up a template (a script file, content files, a thumbnail file representing the design of the template, etc.,) and user files representing photo images merged into the template and the like into one file. For example, assume that there are a digital camera wherein the file manipulation program can be executed and a personal computer (PC) to which a printer is connected, wherein the file manipulation program can be executed, and that the user file representing the image photographed with the digital camera is printed in the PC. In this case, if the user file created in the digital camera and the script file, etc., making up the template used to print the user file are packaged in the digital camera and are output to nonvolatile removable memory, handling is facilitated when the file related to the template is moved to another directory or the user file, the script file, and the like attached to electronic mail are distributed to acquaintances in the PC to which the data in the digital camera is input through the removable memory. If the files making up the template and the user file are packaged and distributed, others can be allowed to produce print display or screen display of the user file according to a specific layout.

The user file and the files making up the template can be related to each other as relating information of the user file photographed just before and the files making up the template to each other is described in another file just after photographing. In this case, the relating described in the file maybe referenced for specifying the files to be packaged.

Of course, the files making up the template and the user file may be saved as one package file just after photographing of the digital camera. That is, just after the user file and the files making up the template are temporarily stored in work memory such as RAM, they may be converted into a package file for output to nonvolatile memory without converting the user file and the files making up the template into a package file for re-output to the nonvolatile memory in response to a user's command after the user file and the files making up the template are once output to the nonvolatile memory.

FIG. 19 (C) is a schematic drawing to show an example of packaging a multipage script file describing the storage positions and the file names of a plurality of script files, the plurality of script files specified in the multipage script file, content files, and user files into one file. As the multipage script file is specified at the printing time, it is made possible to print a plurality of user files on a plurality of pages based on a plurality of script files packaged for creating a so-called electronic album. Therefore, if the multipage script file and its related script files, content files, and user files are packaged, portability of the file group to create an electronic album can be improved.

FIG. 19 (D) is a schematic drawing to show an example of packaging a script file describing the address to download a content file and a thumbnail file into one file. For example, a mobile telephone with a camera which has a digital camera function and can be connected to a communication network is known. If a template made up of a script file, etc., is distributed to such a mobile telephone, it is made possible to use the mobile telephone to package the script file and a user file or display a user file in the layout defined in the script file. However, generally the mobile telephone has memory of a small storage capacity as compared with a personal computer, etc., and cannot store a large number of files. If a script file describing the address to download a content file is distributed, only the necessary content file when necessary can be downloaded into the mobile telephone and the storage area of the mobile telephone can be used efficiently. Here, it is assumed that the mobile telephone includes an electronic file manipulation program and can interpret the script file.

FIG. 20 (E) is a schematic drawing to show an example of packaging a script file and user files into one file. For example, when the layout edit apparatus 20 does not include a printer 12 and at the printing time, a package file is transmitted to a predetermined print server and the printer is caused to print from the print server, if a content file is previously stored in the print server, the content file need not be included in the package file transmitted to the print server and the size of the package file can be lessened. Here, it is assumed that a printer is connected to the print server and that the print server includes an electronic file manipulation program and can interpret a script file.

FIG. 20 (F) is a schematic drawing to show an example of packaging a multipage script file, a plurality of script files specified by the multipage script file and describing the addresses to download content files, and a plurality of user files into one file. For example, to print from the print server described above, each content file need not be included in the package file and thus the size of the package file can be lessened and to print a multipage script file is specified, so that a print command can be given collectively.

FIG. 20 (G) is a schematic drawing to show an example of packaging an index file describing the storage positions and the file names of a plurality of script files for defining similar layouts, created for each size of print media, a plurality of script files for defining similar layouts, specified by the index file, content files, and user files into one file. If a script file is created for a print medium of a specific size, print in the layout as intended can be executed only on the print media of the size to which the script file is applied. Assuming that the index file is the selected file and a plurality of script files for defining similar layouts for a specific size are the related files, the size of the print medium to print can be selected from among the sizes to which the subscript files specified by the index file are applied and if any size is selected, print can be executed in the layout as intended and their handling can be facilitated.

FIG. 20 (H) is a schematic drawing to show an example of packaging a plurality of combinations of script files, thumbnail files, and content files into one file. Accordingly, a plurality of script files falling into the same category such as for the New Year or Christmas, for example, and the thumbnail files and the content files related to the script files can be packaged into one package file, and the script files can be handled in category units.

### SECOND EMBODIMENT

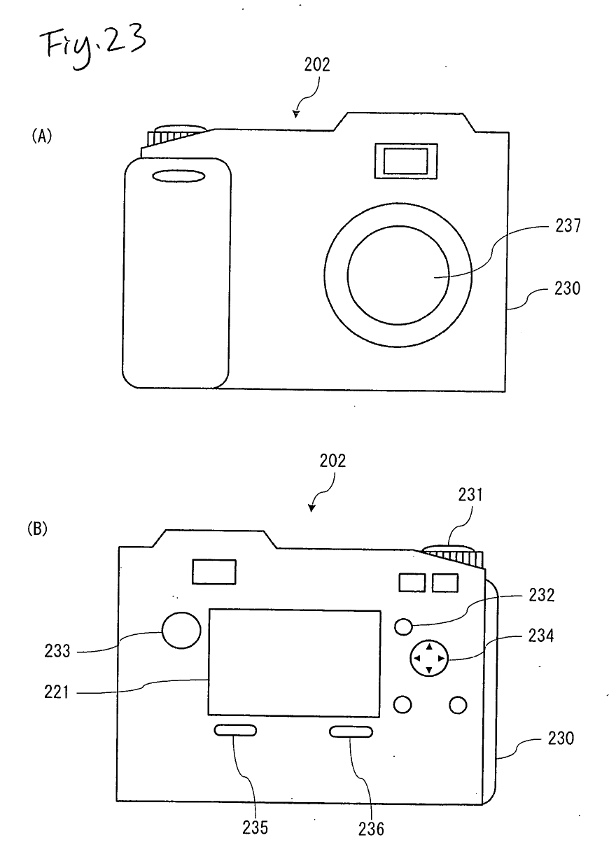

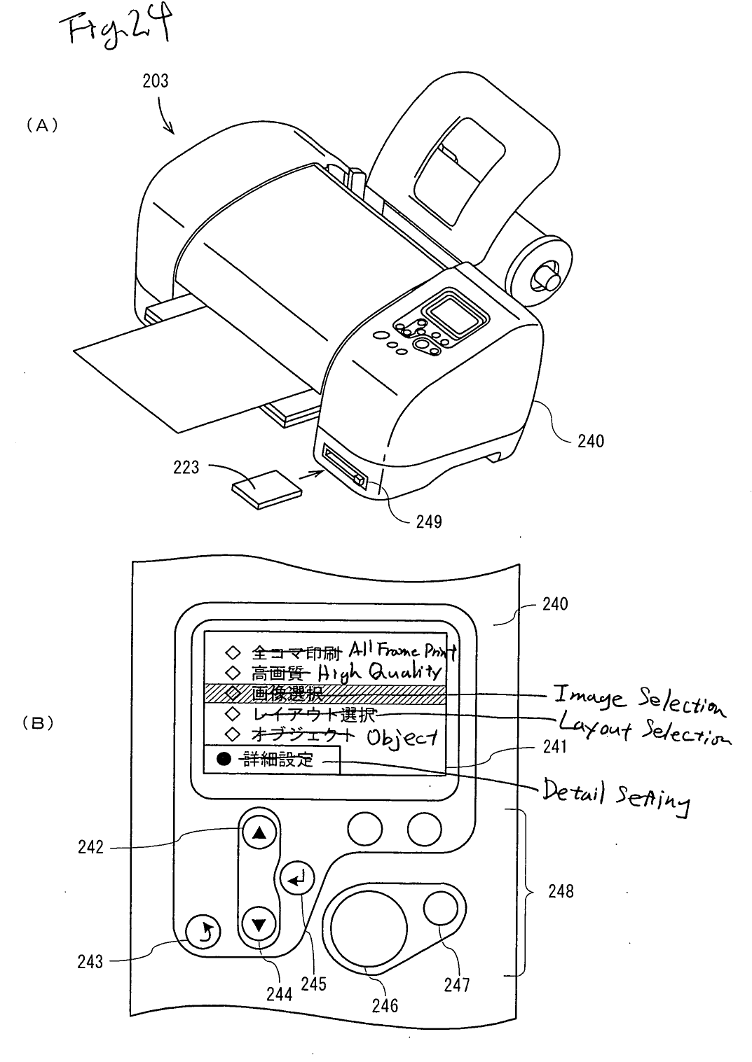

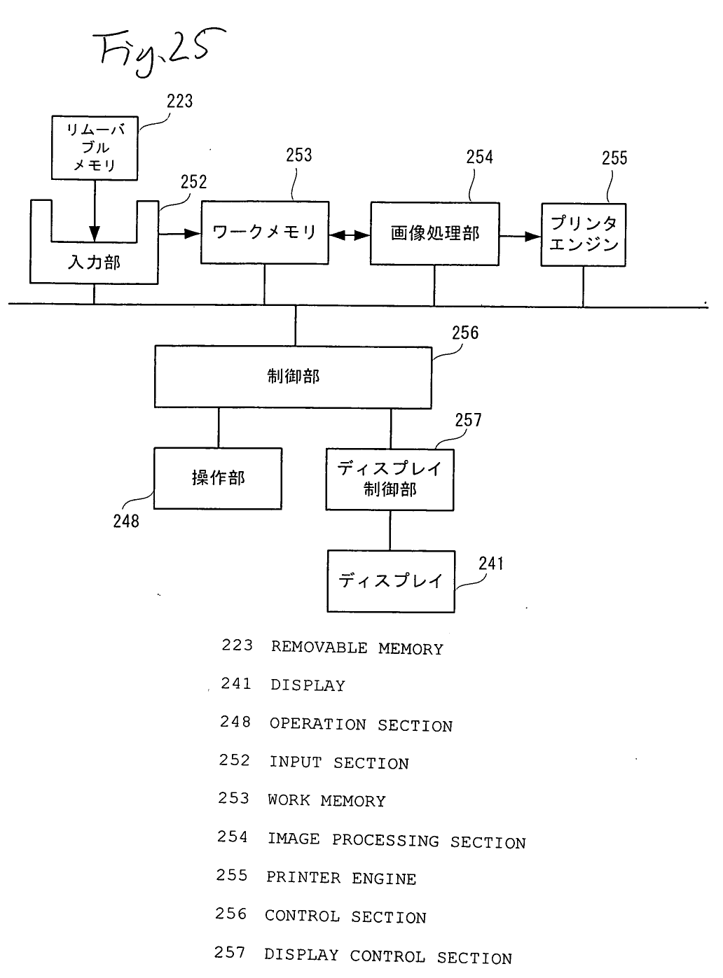

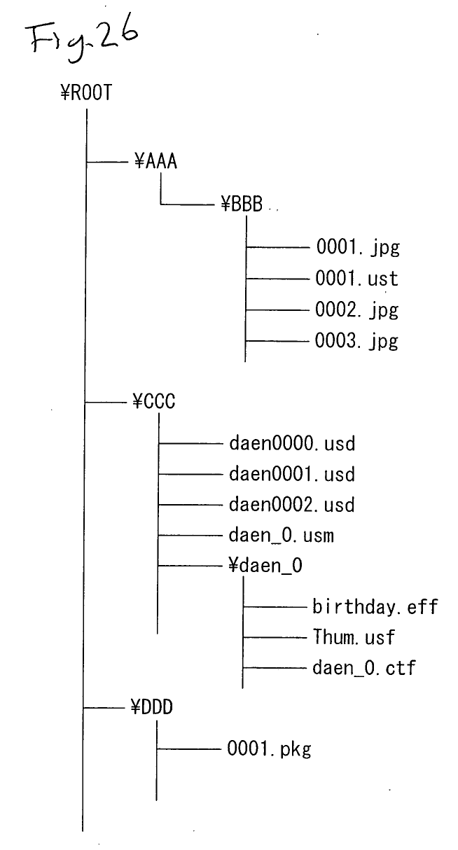

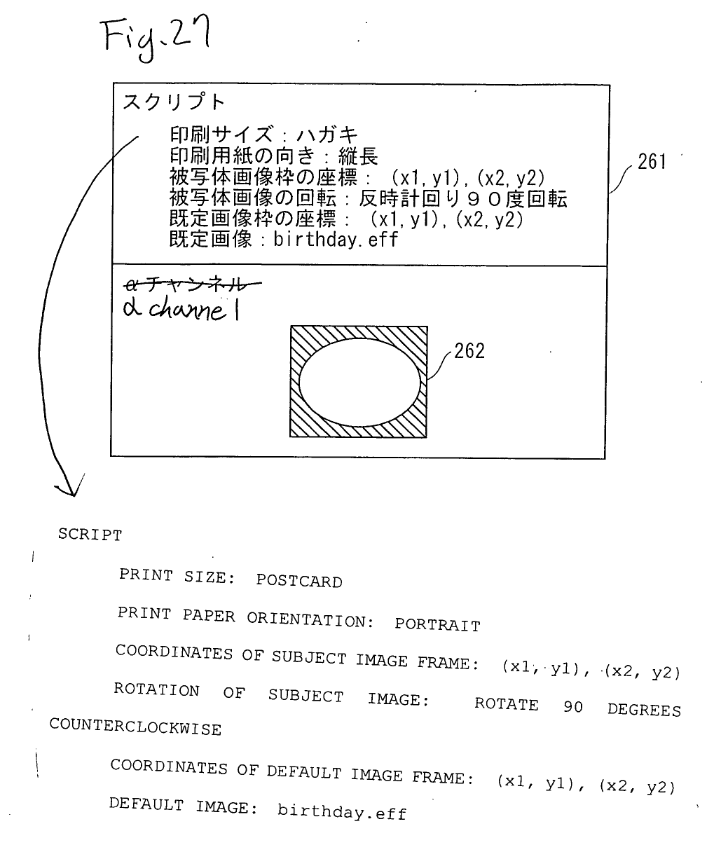

FIG. 21 is a schematic drawing to show an image processing system 201 according to a second embodiment of the invention. As shown in the figure, the image processing system 201 is made up of a digital still camera (DSC) 202 as an image output apparatus and a printer 203 as an image display apparatus. When a digital image file and a layout definition file stored in the DSC 202 are output, they are packaged into a single package file together with other files described later and the package file is written into removable memory 223. The printer 203 reads the package file from the removable memory 223 and acquires necessary files by unpackaging means and prints.

FIG. 22 is a block diagram to show the configuration of the DSC 202. FIGS. 23 (A) and 23 (B) are a front view and a rear view to show the appearance of the DSC 202.

An optical system 210 is made up of a lens 237, an aperture, etc., housed in a cabinet 230. The optical system 210 forms an optical image of a subject on the light reception face of an image sensor 211.

An image pickup section 224 includes the image sensor 211 having photoelectric conversion elements for outputting an electric signal responsive to the light reception amount, a sensor controller 212, an A/D conversion section 213 for performing various types of analog signal processing and quantization processing, an image formation section 214 for performing image formation processing, white balance correction, γ correction, color space conversion, etc., and a compression-decompression section 16 for compressing and decompressing a digital image in a JPEG format, for example.

An output section 222 as output means is controlled by a CPU 216 and writes a package file, etc., into the removable memory 223 placed in a card slot not shown, namely stores the package file, etc. The removable memory 223 is a record medium that can be attached to and detached from the output section 222; specifically it is card-type flash memory that can be attached to and detached from, for example.

An operation section 219 includes pushbutton switches 232, 233, 235, and 236, a cross key 234, a shutter switch 231, etc. The pushbutton switch 232 is a switch for calling a menu on an LCD (Liquid Crystal Display) 221. The pushbutton switches 235 and 236 and the cross key 234 are switches for operating a menu displayed on the LCD 221. The pushbutton switch 233 is a switch for entering an output command. The shutter switch 231 is a switch for entering a still image record command; as the shutter switch 231 is pressed, a still image record command can be entered.

The LCD 221 functions as an electronic view finder and also functions as a display for displaying a photographed digital image, various menus, etc. A display controller 220 includes a frame buffer for storing a digital image of one screen of the LCD 221 and a display circuit for driving the LCD 221 based on the digital image stored in the frame buffer.

The CPU 216 controls the whole DSC 202 by executing a computer program stored in flash memory 217 as internal memory. The CPU 216 also performs processing of packaging, etc. Work memory 218 is memory for temporarily storing a program and data.

FIG. 24 (A) is a perspective view to show the appearance of the printer 203 and FIG. 24 (B) is a drawing to show a display and an operation section of the printer 203 on an enlarged scale.

A card slot 249 is an opening for connecting the removable memory 223 detachably to an input section not shown provided in a housing 240.

As shown in FIG. 24 (B), the housing 240 is provided with a display 241, an operation section 248, etc., and the operation section 224 is provided with a plurality of switches such as an up switch 242, a down switch 244, a determination switch 245, a return switch 243, a print switch 246, and a cancel switch 247. A menu for making various settings is displayed on the display 241. The up switch 242, the down switch 244, the determination switch 245, and the return switch 245 are switches for selecting a menu item. The print switch 246 is a switch for entering a print start command. The cancel switch 247 is a switch for entering a print cancel command. A power circuit, a control circuit, a drive circuit, a printer engine, and the like for producing display are housed in the housing 240.

FIG. 25 is a block diagram of the printer 203.

The display 241 is implemented as an LCD (Liquid Crystal Display), etc., and is controlled by a display control section 257. The display control section 257 includes VRAM, a drive circuit, etc. The display control section 257 displays various menus, a display apparatus thumbnail described later, etc., on the display 241 under the control of a control section 256.

An input section 252 as output means reads a package file, etc., stored in the removable memory 223 and stores the read package file, etc., in work memory 253 under the control of the control section 256.

An image processing section 254 is an ASIC for executing processing to convert the data stored in the work memory 253 into print data in cooperation with the control section 256.

A printer engine 255 is controlled by the control section 256 and forms an image on print paper based on the print data generated in the image processing section 254. The printer engine 255 forms an image according to an ink jet system, a laser system, a sublimation dye transfer printing system, etc., for example.

The control section 256 includes a CPU and ROM as nonvolatile memory. The CPU executes a computer program stored in flash memory 217 as internal memory for controlling the whole of the printer 203. The CPU also performs processing of unpackaging, etc. The ROM is memory previously storing various programs, data, etc.

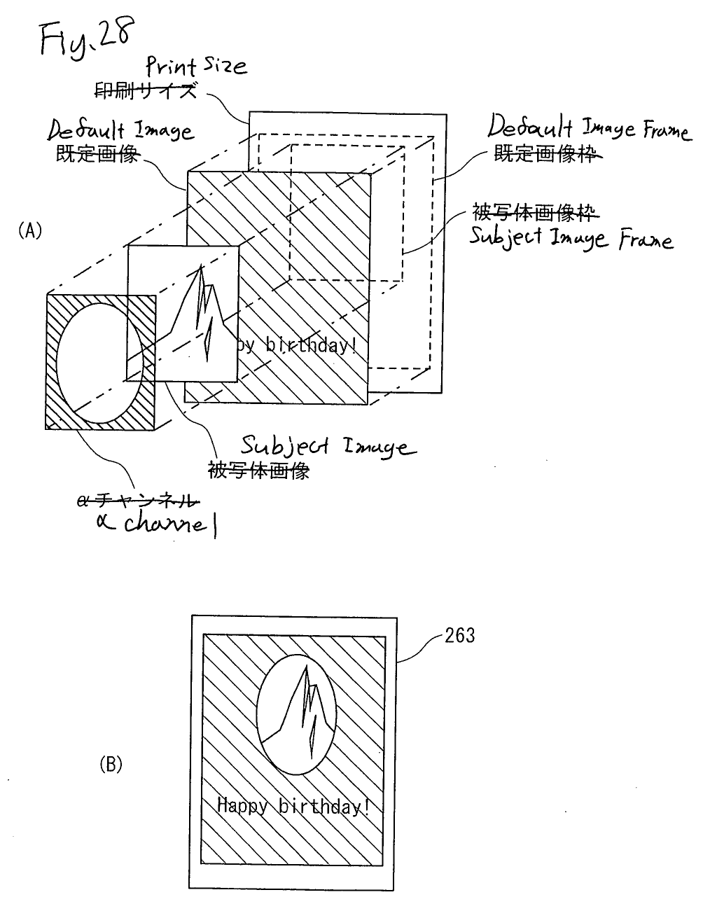

FIG. 26 is a schematic drawing to show the files stored in the removable memory 223 together with the directory structure. FIG. 27 represents a state after a package file is output.

A file with extension “.jpg” is a digital image file for representing a digital image representing a subject (subject image).

A file with extension “.usd” contains information for defining the layout at the display time of a subject image and a default image to be combined with the subject image at the display time (layout definition file) and is retained for each paper size. The layout definition file is described later in detail. A file with extension “.usm” is an index file. Index information of a plurality of layout definition files different in paper size and having similitude relation is described in the index file. Specifically, for example, the number of layout definition files having similitude relation, the file names of the layout definition files having similitude relation, and the like are described in the index file. A file with extension “.eff” is a digital image file for representing a default image to be combined with a subject image based on the layout definition file (default image file). A file with extension “.usf” contains a display apparatus thumbnail. The display apparatus thumbnail is a thumbnail image file for displaying the layout defined in the layout definition file on a display of the printer 203, a personal computer, etc. A file with extension “.ctf” contains a camera thumbnail. The camera thumbnail is a thumbnail image file for displaying the layout defined in the layout definition file and default image on the LCD 221 of the DSC 202 as an image. The camera thumbnail is a file used to select the layout definition data to be associated with a digital image file in the DSC 202 and is a file not packaged. The default image file, the display apparatus thumbnail, and the camera thumbnail are stored in the folder of the same name as the file name of the index file describing the file name of the layout definition file defining the layout displayed by the display apparatus thumbnail and the camera thumbnail. That is, the display apparatus thumbnail and the camera thumbnail are associated with the index file by the name of the folder in which the display apparatus thumbnail and the camera thumbnail are stored. A file with extension “.ust” is an associating file. The associating file is described later. A file with extension “.pkg” is a package file. The package file is also described later.

FIG. 27 is a schematic drawing to show the contents of a layout definition file 261. FIG. 28 (A) is a schematic drawing to describe an image displayed using the layout definition file 261. FIG. 28 (B) is a plan view to show a postcard 263 printed using the layout definition file 261. The layout of the subject image is defined in the layout definition file 261 by a script. The script defines position information to place the subject image on print paper, information to rotate the subject image and place the subject image on print paper, information to scale up or down the subject image, etc., so that they can be interpreted uniquely in the printer 203, etc. Specifically, for example, the script describes the paper size (for example, “postcard”), information to define the print paper orientation (for example, “portrait”), information to define the frame for placing the subject image (subject image frame) (for example, upper left coordinates of the frame “(x1, y1)” and lower right coordinates of the frame “(x2, y2)”), information to define rotation when the subject image is placed in the frame (for example, “rotate 90 degrees counterclockwise”), etc.

Information to specify the default image to be combined with the subject image (for example, “birthday.eff” as the file name of the default image file), information to define the frame for placing the default image (for example, upper left coordinates of the frame “(x1, y1)” and lower right coordinates of the frame “(x2, y2)”), information to define an α channel (for example, tag of α channel), etc., may be described in the layout definition file 261 by a script. An α channel 262 may be stored in the layout definition file 261. The α channel is information defining pixels of which of two images to reflect on the composite image for each pixel when the two images are superposed. Selecting the layout definition file 261 in which the information to specify the default image is described by the script is equivalent to selecting the default image.

In the description that follows, the layout definition file, the index file, the default image file, the associating file, and the display apparatus thumbnail are collectively called layout file set.

Next, the package file will be discussed. The package file described here is an example for packaging combinations of digital image files and layout file sets into a single package file.

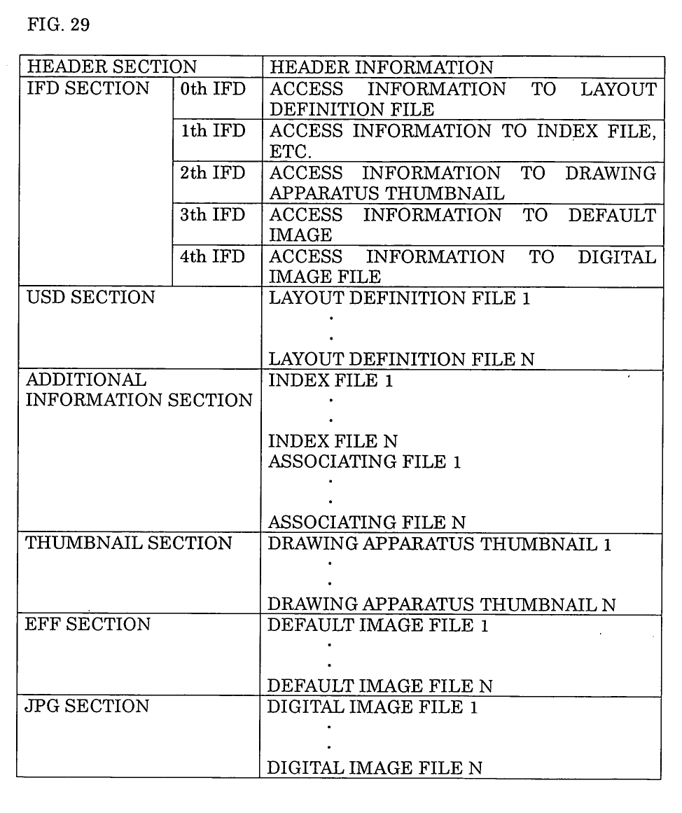

FIG. 29 is a drawing to show an example of the file format of the package file. As shown in the figure, the package file is made up of a Header section, an IFD section, a USD section, an additional information section, a thumbnail section, an EFF section, and a JPG section. Header information of an identifier indicating that the file is a package file, the major version number of the file format, the minor version number, a pointer of “0th IFD” subsection described later, etc., is described in the Header section. The IFD section is a section to store access information for accessing the files stored in the package file and is made up of five subsections of “0th IFD” to “4th IFD.” The subsections are described later. One or more layout definition files are stored in the USD section; one or more index files and one or more associating files are stored in the additional information section; one or more display apparatus thumbnails are stored in the thumbnail section; one or more default image files are stored in the EFF section; and one or more digital image files are stored in the JPG section.

A separate package file may be created for each of combinations of digital image files and layout file sets. For example, the address to download a default image file and/or a display apparatus thumbnail may be described in the layout definition file so as to skip packaging the default image file and/or the display apparatus thumbnail. If the printer 203 can be connected to a communication network, the printer 203 may download the default image file and/or the display apparatus thumbnail based on the address from a server on the communication network at the printing time, and the size of the package file can be lessened. If other files are not necessary, only a digital image file and a layout definition file may be packaged.

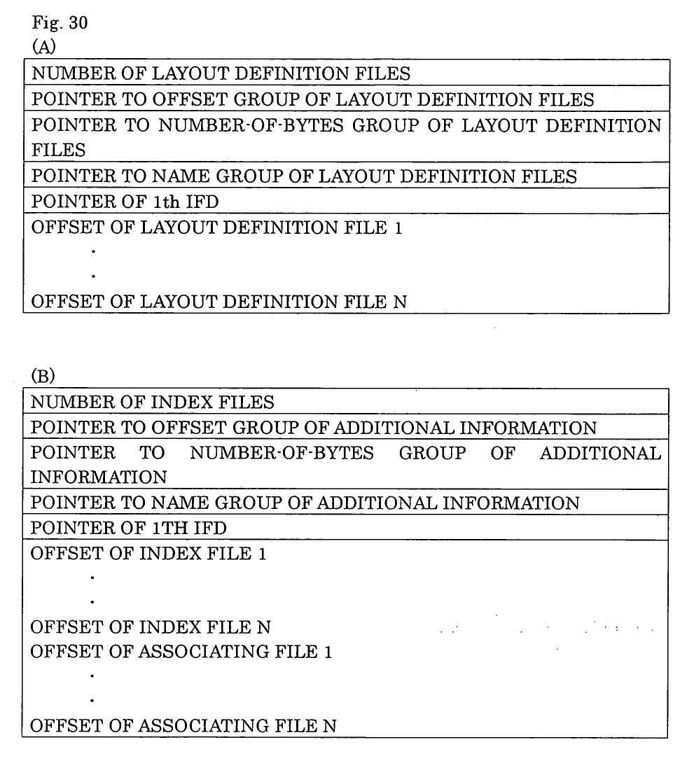

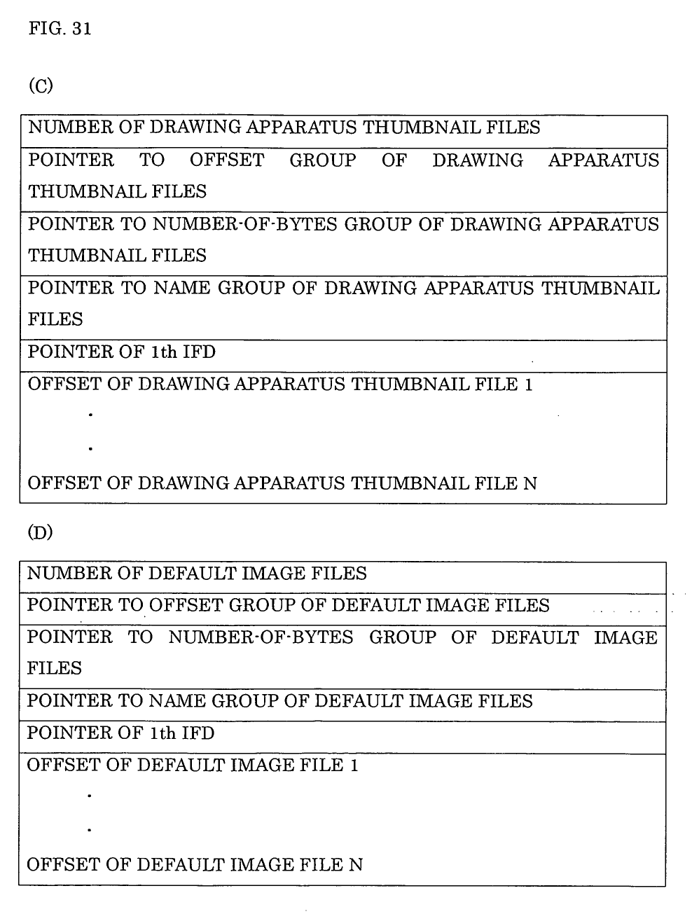

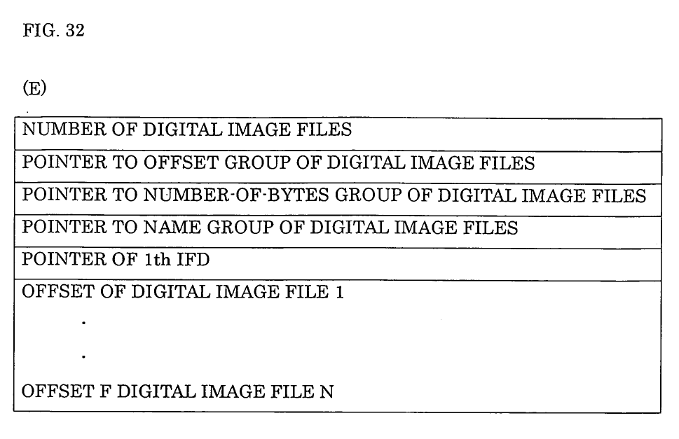

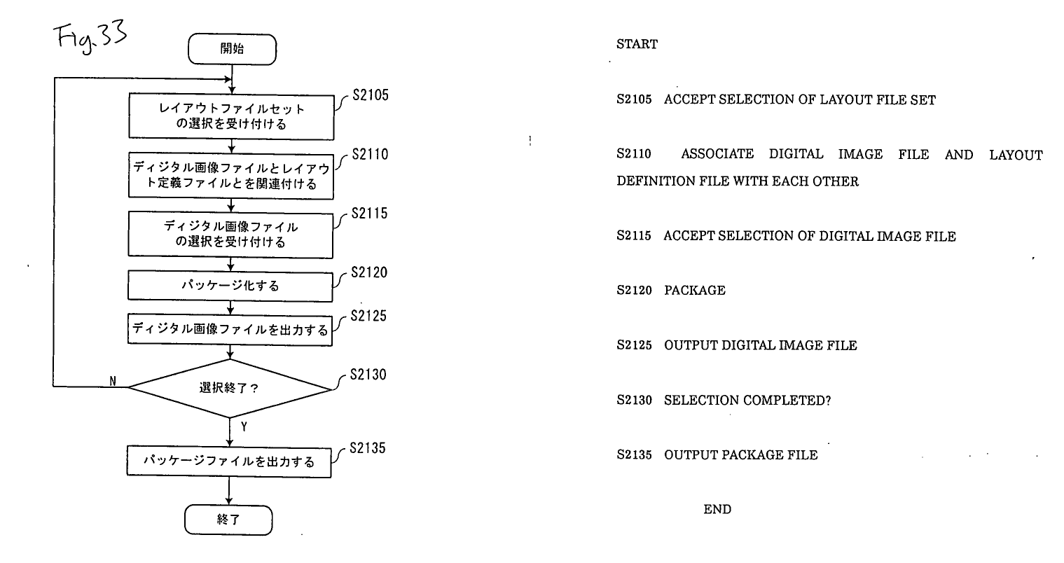

FIG. 30 (A), FIG. 30 (B), FIG. 31 (C), FIG. 31 (D), and FIG. 32 (E) are drawings to show the formats of the “0th IFD” to “4th IFD” subsections. Here, the “0th IFD” subsection shown in FIG. 30 (A) is taken as an example in the description. “Number of layout definition files” is a field indicating the number of layout definition files stored in the package file. “Pointer to offset group of layout definition files” is a field storing the pointer pointing to the position of the top element of “offset to layout definition file 1” to “offset to layout definition file N” in the subsection. For example, to access the first layout definition file stored, the “offset to layout definition file 1” is accessed based on the “pointer to offset group of layout definition files” and the first layout definition file is accessed using the offset value stored in the “offset to layout definition file 1.” To access the number of bytes or the name (file name) of each layout definition file, similar description applies. “Pointer to 1st IFD” is a field storing the pointer to access the “1th IFD” subsection.

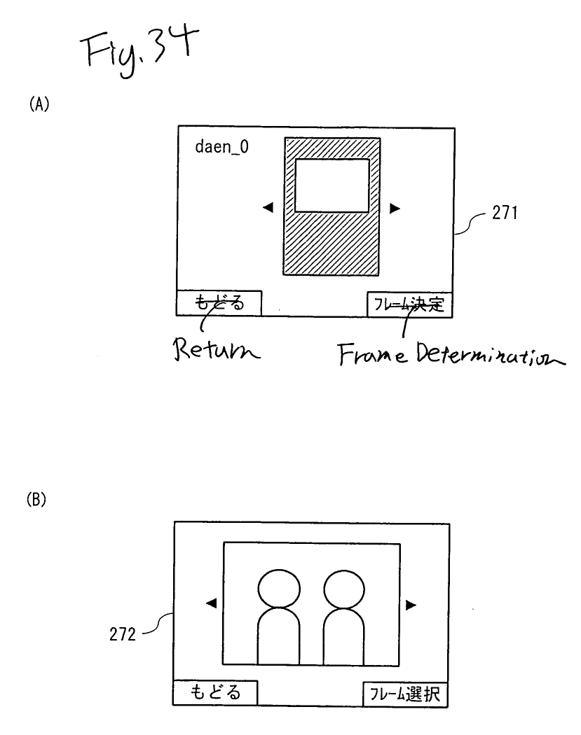

FIG. 33 is a flowchart to show a flow of output processing of a package file.

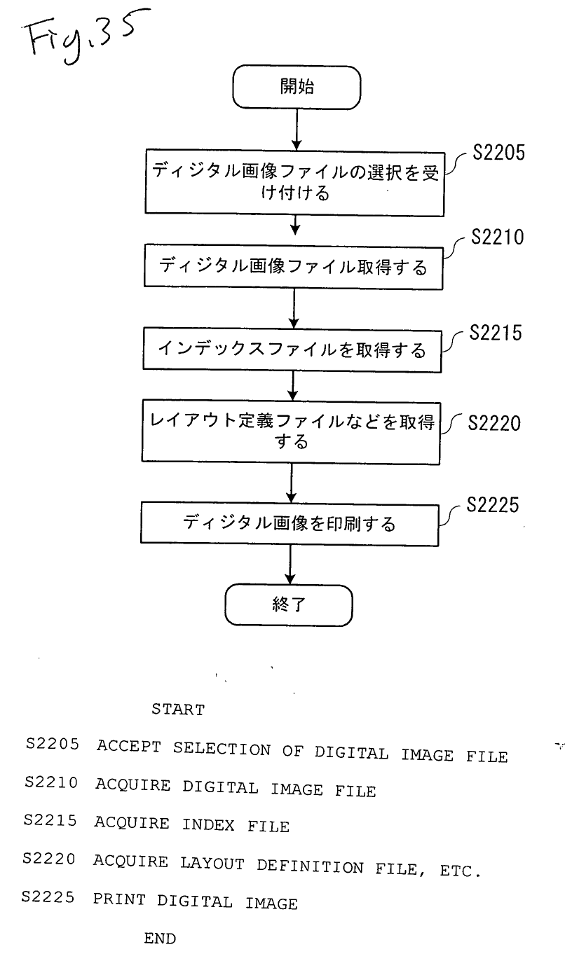

At step S2105, selection of a layout file set is accepted. Specifically, for example, a screen 271 shown in FIG. 34 (A) is output to the LCD 221 for requesting the user to select a layout file set. If the right end or the left end of the cross key 234 is pressed on the screen 271, the DSC 202 displays the camera thumbnails associated with the layout file set recorded in the removable memory 223 in order. The user pushes the pushbutton switch 236 in a state in which the camera thumbnail representing the layout to be associated with a digital image to be photographed is displayed. Accordingly, the layout file set is selected.

At step S2110, the user presses the shutter switch 231 for commanding the DSC 202 to take a photograph. When the shutter switch 231 is pressed, the DSC 202 creates a digital image file representing the subject image and associates the digital image file with the layout file set selected at step S2105 for storage in the removable memory 223. Specifically, first the digital image file is stored in a predetermined folder. Next, the associating file describing the file name of the index file in the currently selected layout file set is stored in the same folder as the digital image file. The associating file is given the same file name as the file name of the digital image file. Consequently, the digital image file is stored in the removable memory 223 in association with the currently selected layout file set. The file with extension “.ust” shown in FIG. 26 is the above-described associating file. For example, a file name of “daen_{—}0.usm” is described in the associating file “0001.ust,” for example. That is, the digital image file representing the subject image and the associating file are associated with each other by their file names, and the associating file and the index file are associated with each other by the file name described in the associating file. The index file and the layout definition file are associated with each other by the file name of the layout definition file described in the index file. As the files are associated with each other, a plurality of layout definition files different in paper size and having similitude relation are associated with one digital image file. If the digital image file is associated with the plurality of layout definition files, the relative positional relationship between the digital image representing the subject and the default image can be printed according to a given layout if the print size differs.

At step S2115, selection of an output digital image file is accepted. Specifically, for example, if the right end or the left end of the cross key 234 is pressed on the screen 272 shown in FIG. 34 (B), the DSC 202 displays the digital images represented by the digital image files recorded in the removable memory 223 in order. The user selects the digital image file by displaying the target digital image. After selecting the digital image file, the user pushes the pushbutton switch 233 to enter an output command.

At step S2120, the DSC 202 creates a single package file from the digital image file selected by the user and the layout file set associated with the digital image file. Therefore, the digital image file and the layout definition file are packaged into the single package file. If the processing at step S2120 is the second or later, packaging is performed by adding to the package file provided at the preceding processing at step S2120. At the time, the file names including the directory name are stored in the names (file names) of display apparatus thumbnails 1 to N in “2th IFD” to maintain the associating. The DSC 202 packages the layout file set associated with the selected digital image file, so that the user may select only the digital image file at packaging and need not select any layout file set. Therefore, the labor and time for packaging can be decreased.

At step S2125, the selected digital image file is stored in the removable memory 223 without being packaged.

At step S2130, if selection of the output layout set and the digital image file is complete, the user pushes a predetermined pushbutton switch to enter an end command, and the DSC 202 proceeds to step S2135. If the selection is not complete, the DSC 202 returns to step S2105 and repeats the processing until the selection is complete.

At step S2135, the package file is written into the removable memory 223. Accordingly, the package file is stored. When the package file is stored in the removable memory 223, if the DSC 202 and the printer 203 are placed in a distributed manner, for example, and cannot be connected directly by a cable, the package file can be transferred.

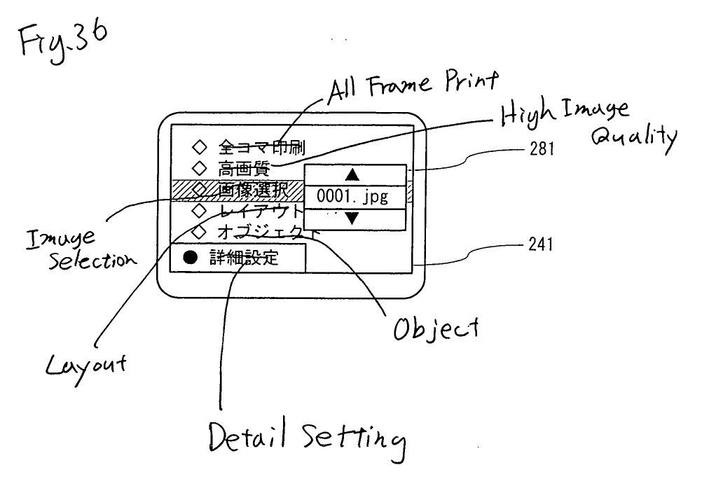

FIG. 35 is a flowchart to show a flow of display processing of the output package file. It is assumed that the user detaches the removable memory 223 from the DSC 202 and attaches the removable memory 223 to the printer 203 before the following processing is performed:

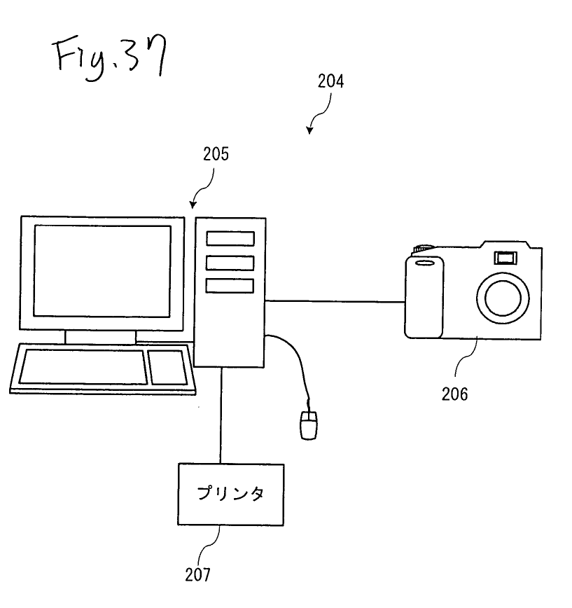

At step S2205, selection of the digital image file to print is accepted. Specifically, for example, a menu 281 shown in FIG. 36 is output to the LCD 221 for requesting the user to select the digital image file. The menu 281 is displayed as a predetermined option is selected in a predetermined high-level menu. When the user selects the predetermined option, the printer 203 reads the package file from the removable memory 223. Accordingly, the package file is input to the printer 203. Next, all names (file names) of the digital image files are read from the read package file. Next, the file names are listed as shown in the menu 281. If digital image files different from the digital image files packaged into the package file are stored in the removable memory 223, it is advisable to also list the file names of the different digital image files. The user operates the up switch 242 or the down switch 244 in the operation section 248 to display the target file name, and presses the determination switch 245.

At step S2210, the printer 203 reads the digital image file of the file name selected at step S2205 from the package file to acquire the digital image file.

At step S2215, the index file of the same file name as the digital image file selected at step S2205 is acquired.

At step S2220, the layout definition file specified by the fetched index file and the digital image file representing a default image are acquired.

At step S2225, the digital image represented by the acquired digital image file is printed based on the acquired layout definition file.

The printer 203 of the embodiment prints the digital image file based on the layout definition file previously associated in the DSC 202, but the layout definition file used to print may be able to be changed in the printer 203. At this time, it is advisable to take out the display apparatus thumbnails in order from the package file and display the thumbnail on the display. This enables the user to easily select the layout definition file.

According to the image processing system 201 of the second embodiment described above, the DSC 203 outputs the digital image file and the layout file set made up of a plurality of files as a package file. Thus, for example, if the user wants to distribute the output digital image file and layout file set to friends in such a manner that they are copied into a flexible disk or are attached to electronic mail, the distributing time and labor can be decreased because the digital image file and the layout file set are packaged into a single package file. Further, an error of forgetting about copying one of the files or the like can be prevented. Therefore, portability is improved.

When the package file is stored in the removable memory 223, it is advisable to also store the digital image file stored in the package file in a state in which the digital image file is not packaged. Accordingly, the digital image file not packaged can be distributed to a person who does not have a printer 203.

### THIRD EMBODIMENT

In the description of a third embodiment, the case where a package file is transmitted to a communication line is taken as an example. Parts in the third embodiment substantially identical with those in the second embodiment will not be discussed again.

FIG. 37 is a schematic drawing to show an image processing system 204 according to the third embodiment of the invention. As shown in the figure, the image processing system 204 is made up of a DSC 206 as an image output apparatus and a personal computer (PC) 205 and a printer 207 connected to the PC 205 as an image display apparatus. The DSC 206 includes an output section configured in conformity with USB (Universal Serial Bus) standard as output means and likewise the PC 205 includes an input section configured in conformity with the USB standard as input means; the DSC 206 and the PC 205 are connected so that they can communicate with each other over a communication cable conforming to the USB standard. An image edit program is stored on a hard disk included in the PC 205. The image edit program is a program for executing processing of unpackaging a package file, display processing of the digital image represented by a digital image file on a display based on a layout definition file, processing of causing the printer 207 to print a digital image based on a layout definition file, etc.

The operation of the image processing system 204 is as follows:

The DSC 206 transmits a package file to the communication cable as a communication line. Specifically, it sends a signal representing the package file from the output section to the communication cable in accordance with the system defined in the USB standard. The PC 205 receives the signal representing the package file from the communication cable at the input section and stores the package file on the hard disk included in the PC 205. If the user enters a command to execute the image edit program, the PC 205 executes the image edit program, acquires the digital image file selected by the user from the package file, and acquires the layout file set associated with the selected digital image file. Next, the PC 205 displays the digital image represented by the digital image file on a display included in the PC 205 based on the layout file set. When the user enters a print command, the PC 205 generates print data based on the digital image file and the layout file set and causes the printer 207 to print the digital image. To acquire files, the PC 205 may collectively acquire all packaged files for storage on the hard disk or may acquire a file each time the file is selected.

According to the image processing system 204 of the third embodiment described above, the package file can be transferred via the communication cable and removable memory need not be attached, detached, etc., so that the time and labor for transferring the package file can be decreased.

When the user wants to move the digital image file and the layout definition file to another direction or distribute the files to another personal computer, for example, in the PC 205 after reception, the files are a single file as a package file and thus can be handled easily.

The embodiment has been described by taking as the communication line the communication cable conforming to the USB standard as an example, but the DSC 206 and the PC 205 may be connected through a communication network and the communication line may be a LAN, a telephone line, or a radio line of Bluetooth, etc., for example.

In the third embodiment, the image display apparatus is made up of the PC 205 and the printer 207, but may be made up of only the DSC 206 and the PC 205 if display only is needed.

### FOURTH EMBODIMENT

A fourth embodiment of the invention is a layout edit program as a display data processing program for setting the use limitation in a package file. The layout edit program of the fourth embodiment is provided by adding a function of setting the use limitation to the layout edit program of the first embodiment.

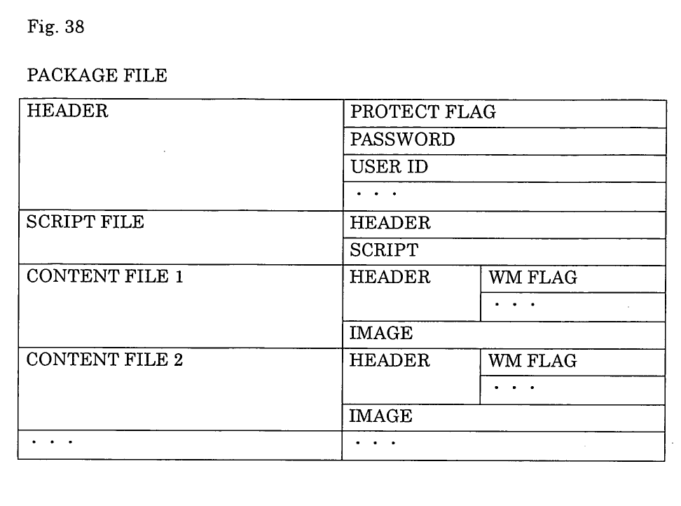

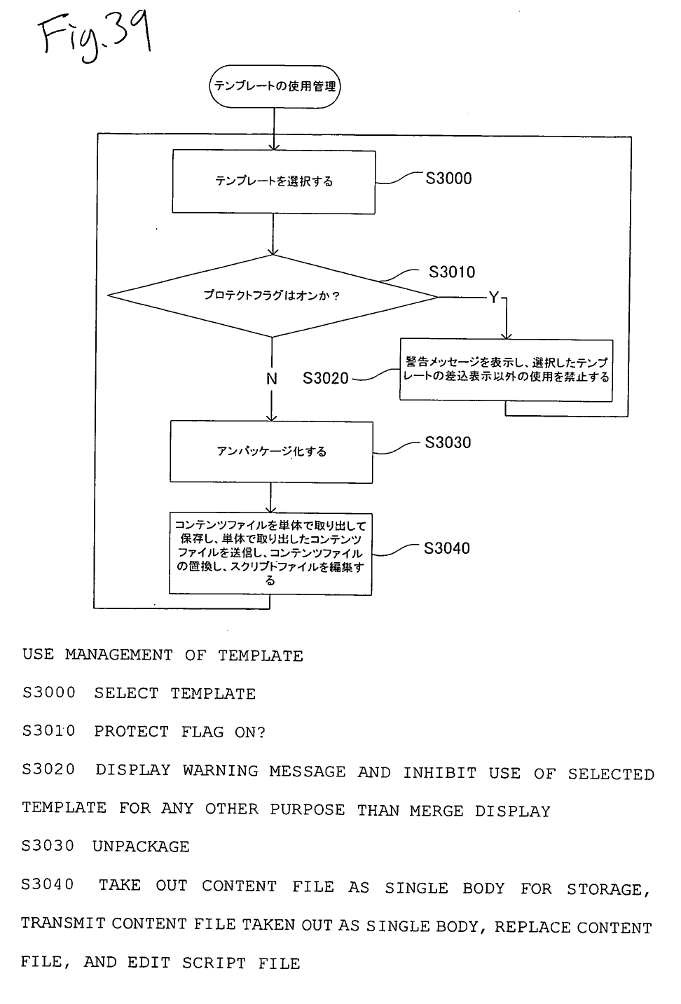

FIG. 38 is a data structure drawing of a single package file created based on content files representing image elements and a script file as a layout control file for controlling the layout of the image elements.

A protect flag as use limitation data stored in a header of a package file is a flag for setting inhibition or permission of use of the package file for any other purpose than merge display. Specifically, for example, the protect flag is a flag for setting inhibition or permission of editing a script file, taking out a content file as a single body from the package file for storage, or transferring a content file taken out as a single body to another system, for example. The minimum-unit information represented by the use limitation data may be represented as data of two bits or more rather than a flag.

A watermark flag (WM flag) stored in the header of the section corresponding to each content file is a flag indicating whether or not a watermark as a digital watermark is added to the image represented by the content file.

A password as control data stored in the header of the package file is information referenced by a program for removing the watermark of each content file stored in the package file. The program for removing the watermark can remove the watermark added to each image element in the package file only if the password of an appropriate value is stored in the package file. Therefore, even if any content file is taken out as a single body from the package file and is displayed as a single body, if a watermark is added to the image element represented by the content file, displaying the image element with the watermark removed is made impossible.

When the layout edit program converts the files making up a template such as a script file and content files into one package file as the user specifies “save with package,” the layout edit program requests the user to set the protect flag and select addition or no addition of a watermark to the image element in each content file. For example, when the user causes an event of yes to occur in response to display of a message of “Do you inhibit secondary use of content file?” a water mark is added to the image element and the watermark flag is set to ON. As a method of adding a watermark to each image element, a method of changing the pixel value of the image element based on a predetermined rule is known.

For example, when the user causes an event of yes to occur in response to display of a message of “Do you inhibit edit of template?” the protect flag is set to ON. ON of the protect flag corresponds to “inhibition” and OFF corresponds to “permission.”

### FIFTH EMBODIMENT

A fifth embodiment of the invention is a display data processing program for managing the use of a package file in response to the descriptions of the use limitation data described above. The display data program of the fifth embodiment is provided by adding a function of managing the use of a package file in response to the descriptions of the use limitation data to the layout edit program of the first embodiment. A computer for executing the display data program is connected to a printer and a photo image represented by a user file can be merged into a package file input to the computer for print display.

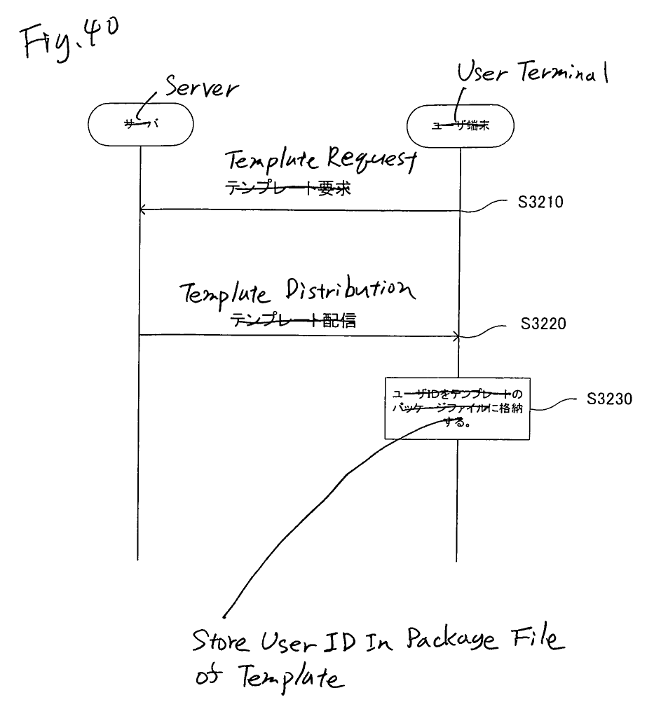

FIG. 39 is a flowchart to show a flow of management processing of the use of a package file by the display data processing program.

To begin with, the user is requested to select a template used for any other purpose than merge display (S3000). That is, the user is requested to select the package file into which the files making up the template used outside control of a script are packaged.

Next, the protect flag of the selected package file is referenced (S3010). If the protect flag is set to ON, a warning message is displayed and the use of the selected template for any other purpose than merge display is inhibited (S3020). That is, the package file is not unpackaged and individual use of the data corresponding to the script file, the content files, etc., converted into the package file is inhibited. For example, editing the script file to change the layout of the copyrighted image element represented by the content file or extracting only the copyrighted content files for storage is inhibited. Even if the protect flag is ON, if the script file, the content files, etc., provided by unpackaging the package file are not stored in nonvolatile memory such as a hard disk or removable memory, temporary storing the script file, the content files, etc., provided by unpackaging the package file only in volatile work memory may be permitted.

If the protect file is set to OFF, the selected package file is unpackaged (S3030) and individual use of the files making up the template such as the script file and the content files is permitted (S3040). That is, specifically, for example, a user command to copy the content file provided by unpackaging the package file into any directory specified by the user, to transmit the content file to a remote location with the content file attached to electronic mail, to edit the script, or to replace the content file corresponding to the image element whose layout is controlled by the script file with a different content file is accepted and processing corresponding to the accepted command is executed. The use limitation data may be a flag for individually inhibiting or permitting the use modes rather than a flag for collectively inhibiting or permitting the use modes.

### SIXTH EMBODIMENT

A sixth embodiment of the invention is a display data management method of downloading a package file forming a template from a server to a user terminal and making it possible to produce merge display using the package file in the user terminal while preventing illegal use.

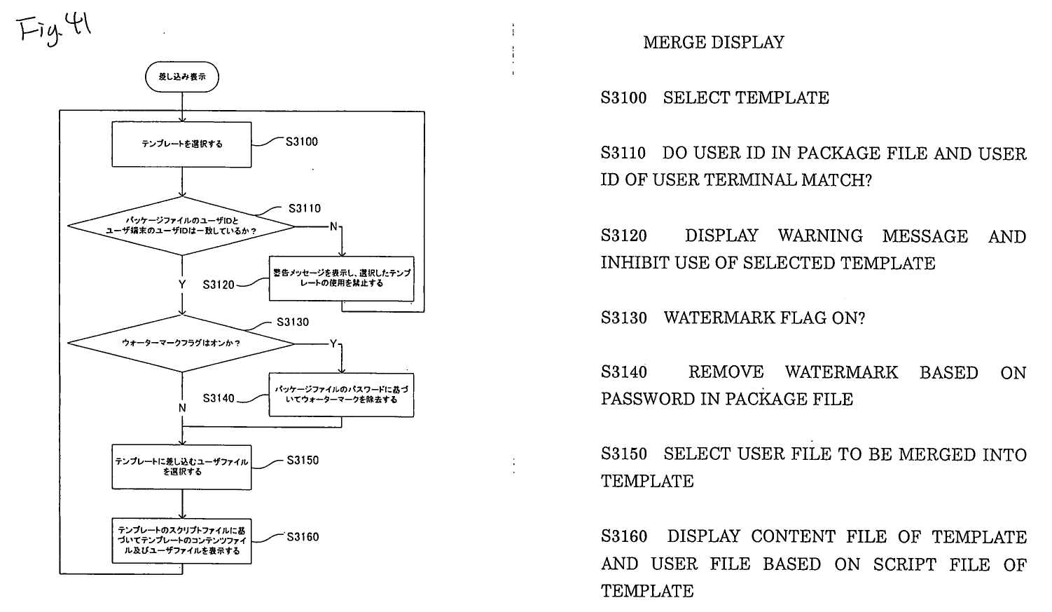

FIG. 40 is a sequence chart to describe the display data management method of the sixth embodiment.

The user terminal may be not only the print system of the first embodiment, but also a portable information terminal such as a mobile telephone with a camera not directly connected to a printer. The server may be implemented as a general-purpose personal computer for executing the layout edit program of the fourth embodiment or may be a dedicated computer including a large-capacity storage section for opening package files corresponding to a large number of templates to the public.

To begin with, the user makes a request for a template from a specific program in the user terminal (S3210). Specifically, for example, the user accesses a predetermined URL on the Internet using the specific program in the user terminal, causes the server to transmit a template selection page to the user terminal, and transmits the URL storing a predetermined template to the server as a response to the page. At this time, the server may reject the template request by a program different from specific programs distributed only to specific users.

The server receiving the template request transmits the package file forming the template selected by the user to the user terminal (S3220). At this time, the data structure of the package file transmitted by the server is the same as the data structure of the package file described in the fourth embodiment.

In the user terminal as the reception terminal, a user ID is stored in the header of the received package file (see FIG. 38) by the template requesting program just after the template is received (S3230). The user ID as identification information proper to the user terminal may be the password set by the user when installing the template requesting program, may be the proper identification number preset in the user terminal, or may be the telephone number if the user terminal is a mobile telephone. As the user ID is thus stored in the package file just after distribution, when the package file is used, it is made possible to make a comparison between the user ID of the terminal using the package file and the user ID stored in the package file, so that it is made possible to allow only specific users to use the package file.

The user ID proper to the user terminal to receive the package file may be transmitted from the user terminal to the server, which may then store the user ID in the package file and transmit the package file with the user ID stored therein to the user terminal.

FIG. 41 is a flowchart to show a flow of processing of merging an image element into a template for display in a user terminal.

To begin with, the user is requested to select a template used for merge print (S3100). That is, the user is requested to select at least one of package files forming template received from the server and previously stored.

Next, whether or not the user ID stored in the header of the selected package file (see FIG. 38) and the user ID proper to the user terminal match is checked (S3110). If it is assumed that the package file received at a specific terminal from the server is transferred to a different terminal, the user ID stored in the header of the package file just after reception from the server and the user ID proper to the user terminal checking two IDs do not match.

If the two user IDs do not match as a result of checking the user IDs, a warning message is displayed and use of the selected template is inhibited (S3120). That is, not only merge display using the selected template, but also unpackaging the template and individual use of the data contained in the template are inhibited.

If the two user IDs match as a result of checking the user IDs, the package file is unpackaged and the WM flag of each content file is checked (S3130). If the WM flag is ON, the watermark is removed based on the password in the package file (S3140). Specifically, for example, a predetermined program for removing the watermark (which will be hereinafter referred to as removal program) is started, the password in the package file is input to the removal program, and the watermark added to the image element represented by the content file is removed by the removal program. As a method of removing the watermark, for example, the pixel value representing the image element represented by the content file may be changed based on the rule corresponding to the rule adding the watermark.

Next, the user is requested to select the user file representing the image element to be merged into the template (S3150). At this time, the selected user file may be an image file representing a photo image previously input to a computer or may be an image file representing a photo image taken by a mobile telephone with a camera if the user terminal is a mobile telephone with a camera. The user file may be selected before the template is selected.

Next, the image element selected by the user is merged into the template selected by the user for screen display or print display (S3160). Specifically, the image element represented by the content file and the image element represented by the user file selected by the user are displayed based on the script file forming the template selected by the user.

Although the embodiments of the invention have been described using the embodiments, it is to be understood that the invention is not limited to the specific embodiments thereof and various modifications and changes may be made without departing from the spirit and the scope of the invention, of course.

1. An electronic file manipulation method used to manipulate an electronic file, said method comprising:
a packaging step of packaging a selected file and at least one related file related to the file into a single file; and
an unpackaging step of unpackaging the package provided by packaging the files into the selected file and the related file.

2. An electronic file manipulation method used to manipulate an electronic file, said method comprising:
a packaging step of packaging a selected file and a file related to the file into a single file.

3. An electronic file manipulation method used to manipulate an electronic file, said method comprising:
a file analysis step of analyzing a package file into which a selected file and a file related to the file are packaged as a single file, as the selected file and the file related to the file.

4. A layout edit apparatus for editing a layout of an image area for displaying an image, said apparatus comprising:
layout edit means for placing at least one image and at least one merge image area into which an image can be merged and editing a layout; and
file manipulation means for manipulating a file using a method as claimed in claim 1, wherein
said file manipulation means is file manipulation means for adopting an information file containing information concerning placement of the image and the image area in the layout created and information concerning an image file used with the layout as the selected file and at least one file used with the layout as the related file.

5. A layout edit apparatus for editing a layout of an image area for displaying an image, said apparatus comprising:
layout edit means for placing at least one image and at least one merge image area into which an image can be merged and editing a layout; and
file output means for outputting an information file containing information concerning placement of the image and the image area in the layout created and information concerning an image file used with the layout and at least one file used with the layout as a single package file.

6. An image processing system comprising an image output apparatus for outputting a digital image file and a layout definition file for defining a layout to display a digital image represented by the digital image file and an image display apparatus for displaying the digital image represented by the output digital image file based on the layout definition file, characterized in that:
said image output apparatus has packaging means for packaging the digital image file and the layout definition file into a single package file and output means for outputting the single package file, thereby outputting the digital image file and the layout definition file, and that
said image display apparatus has input means for inputting the output package file and unpackaging means for acquiring the digital image file and the layout definition file from the input package file.

7. An image processing method for transferring a digital image file and a layout definition file between an image output apparatus for outputting a digital image file and a layout definition file for defining a layout to display a digital image represented by the digital image file and an image display apparatus for displaying the digital image represented by the output digital image file based on the layout definition file, characterized by:
a packaging step of packaging the digital image file and the layout definition file into a single package file and an output step of outputting the single package file, thereby outputting the digital image file and the layout definition file in said image output apparatus; and
an input step of inputting the output package file and an unpackaging step of acquiring the digital image file and the layout definition file from the input package file as unpackaging in said image display apparatus.

8. A layout edit method, characterized by:
a user interface step of accepting a command to edit a layout of an image element in a predetermined area on a screen;
a layout edit step of editing a layout control file for controlling the layout of the image element based on the command accepted in said user interface step; and
an output step of converting a content file representing all image elements laid out in the predetermined area and a layout control file for controlling the layout of all image elements laid out in the predetermined area into a single package file and outputting the package file.

9. A layout edit apparatus characterized by:
user interface means for accepting a command to edit a layout of an image element in a predetermined area on a screen;
layout edit means for editing a layout control file for controlling the layout of the image element based on the command accepted by said user interface means; and
output means for converting a content file representing all image elements laid out in the predetermined area and a layout control file for controlling the layout of all image elements laid out in the predetermined area into a single package file and outputting the package file.

10. A display data processing method characterized by:
a storage step of storing files making up a template;
a selection step of selecting an image element to be merged into the template; and
an output step of converting the files making up the template and a user file representing the image element selected in said selection step into a single file and outputting the file.

11. A display data processing apparatus characterized by:
storage means for storing files making up a template;
selection means for selecting an image element to be merged into the template; and
output means for converting the files making up the template and a user file representing the image element selected by said selection means into a single file and outputting the file.

12. A display data processing method characterized by:
a conversion step of converting a content file representing an image element and a layout control file for controlling a layout of the image element into a single package file; and
a use limitation step of storing use limitation data to permit or inhibit individual use of content data contained in the package file representing the image element or layout control data contained in the package file for controlling the layout of the image element in the package file.

13. A display data processing apparatus characterized by:
conversion means for converting a content file representing an image element and a layout control file for controlling a layout of the image element into a single package file; and
use limitation means for storing use limitation data to permit or inhibit individual use of data contained in the package file representing the image element or data contained in the package file for controlling the layout of the image element in the package file.

14. A display data processing method characterized by:
a display step of reading a package file storing content data representing an image element, layout control data for controlling a layout of the image element, and use limitation data and displaying the content data under the control of the layout control data;
an individual use step of reading the package file and using the content data or the layout control data individually; and
a management step of managing access to the package file and permitting or inhibiting the use in response to the use descriptions and the use limitation data.

15. A display data processing apparatus characterized by:
display means for reading a package file storing content data representing an image element, layout control data for controlling a layout of the image element, and use limitation data and displaying the content data under the control of the layout control data;
individual use means for reading the package file and using the content data or the layout control data individually; and
management means for managing access to the package file and permitting or inhibiting the use in response to the use descriptions and the use limitation data.

16. A file data structure characterized by:
a first area in which content data representing an image element is recorded;
a second area in which layout control data for controlling a layout of the image element is recorded; and
a third area in which use limitation data to limit use of the content data or the layout control data is recorded.

17. A display data management method characterized by the steps of:
distributing a package file recording content data representing an image element, layout control data for controlling a layout of the image element, and use limitation data to a reception terminal through a network;
storing identification information proper to the reception terminal in the package file in response to distribution of the package file; and
making a comparison between information proper to a use terminal and the identification information stored in the package file and permitting or inhibiting use of the content data or the layout control data contained in the package file by the use terminal in response to the comparison result.
